(19) United States
(12) Patent Application Publication
(10) Pub. No.: US 2013/0324214 A1
(43) Pub. Date: Dec. 5, 2013

(54) SYSTEMS, METHODS, APPARATUS AND COMPUTER-READABLE MEDIUMS FOR ON-LINE GAMING

(71) Applicant: Nektan Limited, Gibraltar (GI)

(72) Inventors: Gary SHAW, Gibraltar (GI); Richard SAGMAN, Gibraltar (GI)

(73) Assignee: Nektan Limited, Gibraltar (GI)

(21) Appl. No.: 13/899,181

(22) Filed: May 21, 2013

Related U.S. Application Data
(62) Division of application No. 13/117,917, filed on May 27, 2011.
(60) Provisional application No. 61/349,112, filed on May 27, 2010.

(51) Int. Cl. G07F 17/34

(52) U.S. Cl. CPC G07F 17/34
USPC 463/20; 463/16

(57) ABSTRACT

A gaming method, machine and system provide a game of chance which includes a skill feature (312). The gaming method according to one embodiment enables a player to access a game of chance (S55), triggers (S60), in the game of chance, a bonus feature when a predetermined scenario occurs in the game of chance, provides to the player a skill game within the bonus feature (S3), and returns to the game of chance (S85) after the skill game is completed by the player (S70).

### CROSS REFERENCE TO RELATED APPLICATION

This is a divisional application which claims priority to copending U.S. application Ser. No. 13/117,917, filed May 27, 2011 which is a non-provisional application that claims priority under 35 U.S.C. §119(e) to U.S. Provisional Application No. 61/349,112 filed on May 27, 2010, the entire contents of which are hereby incorporated by reference.

### BACKGROUND OF THE INVENTION

1. Field of the Invention

The present invention relates to a gaming technique and gaming apparatus, and more particularly to a method, apparatus and system for playing a slot-type game.

2. Description of the Related Art

Slot games are ubiquitous online and in casinos. These popular games are games of chance where a player may win a prize based on certain arrangements of symbols. Because the result of these games is based on the “luck” of the player, the incentive to play may be diminished by random arrangements of symbols which may be unfavorable to the player or may become unexciting through chance repetition.

Disclosed embodiments of this application include systems, methods, apparatuses and computer-readable mediums and data structures which provide an increased incentive to play a slot game or other game of chance, together with increased player satisfaction based on the result of the game. The embodiments of this application also implement a novel type of interaction between a player and a slot game or other game of chance, and may be provided in a gaming venue, online, or on a mobile device. Systems, methods, apparatuses, computer-readable mediums and data structures, as described herein, provide for a game, that includes a non-skill portion of a game, and a skill portion of the game. The non-skill portion of the game is a game of chance, for example, a slot, where the player does not contribute with skill when determining a win and the payout thereon or a loss. The skill portion of the game is any game of skill where the payout is dependent on the skill of the player. In the present application, an inventive game of one particular embodiment is called “sklot” to indicate that it includes elements of a slot game and elements of skill.

### SUMMARY OF THE INVENTION

The present invention is directed to gaming methods, apparatuses and systems. According to a first aspect of the present invention, a gaming method comprises: enabling a player to access a game of chance; triggering, in the game of chance, a bonus feature when a predetermined scenario occurs in the game of chance; providing to the player a skill game within the bonus feature; and returning to the game of chance after the skill game is completed by the player.

According to a second aspect of the present invention, a gaming machine comprises: at least one processor; and a display device, wherein the at least one processor enables a player to access a game of chance through the display device, the at least one processor triggers, in the game of chance, a bonus feature when a predetermined scenario occurs in the game of chance; and the at least one processor provides to the player a skill game within the bonus feature, wherein the at least one processor returns the player to the game of chance after the skill game is completed by the player.

According to a third aspect of the present invention, a gaming system comprises: a unit for a game of chance; a skill unit; and a skillgaming unit, wherein the units are programmed to operate so that: the unit for the game of chance sends a request for a bonus round game session to the skill unit, during a game of chance played by a player, when a predetermined scenario occurs in the game of chance, the skill unit sends session information to the unit for the game of chance, the unit for the game of chance sends bonus round characteristics to the skillgaming unit, for the bonus round to be played by the player as a skill game, the skillgaming unit sends a player score from the bonus round so that the score reaches the unit for the game of chance.

### BRIEF DESCRIPTION OF THE DRAWINGS

Further aspects and advantages of the present invention will become apparent upon reading the following detailed description in conjunction with the accompanying drawings. The accompanying drawings, which are incorporated in and constitute a part of this specification, illustrate several embodiments of the invention and together with the description, serve to explain the principles of the invention, and, together with the description, explain the features and aspects of the invention.

It may be appreciated that the diagrams are examples of the system environment and the components within the client device and the information depicted therein may be configured in a different manner, as may be appreciated by one skilled in the art.

FIG. 1 is a general block diagram of a system environment in which a sklot game may be played according to an embodiment of the present invention;

FIG. 2 is an exemplary block diagram illustrating components included in client device capable of playing a sklot game according to an embodiment of the present invention illustrated in FIG. 1;

FIG. 3 is an exemplary block diagram of a server that may be implemented in the system environment in which a sklot game may be played according to an embodiment of the present invention;

FIG. 4 is a flow diagram illustrating operations performed when playing sklot according to an embodiment of the present invention;

FIG. 5 is a flow diagram illustrating in mode detail a process flow of playing sklot according to an embodiment of the present invention;

FIG. 6 is a block diagram illustrating in detail exemplary aspects of sklot including the exchange of information between a slot server, a skill server and a skillgaming site and server during a game of sklot when a bonus round is triggered, according to an embodiment of the present invention;

FIGS. 7A-7D illustrate exemplary details of a slot paytable and a bonus paytable for determining a player score in the bonus feature in which a skill sub-game is played according to an embodiment of the present invention;

FIG. 8 is a flow diagram illustrating exemplary steps in a play of sklot according to an embodiment of the present invention;

FIG. 9 is a block diagram illustrating a set-up of a sklot game according to an embodiment of the present invention;

FIG. 10A illustrates an exemplary histogram showing the results and distribution achieved from over 60 k plays on the icicle climb skill game, and FIG. 10B illustrates the percentage of scores within certain ranges in FIG. 10A, according to an embodiment of the present invention;

FIG. 11 illustrates a screen shot showing functional buttons in an exemplary sklot game according to an embodiment of the present invention;

FIG. 12A illustrates an exemplary screen shot showing bonus multiplier animation to an embodiment of the present invention, and FIG. 12B illustrates an exemplary bonus payout table for the game shown in FIG. 12A according to an embodiment of the present invention;

FIG. 13 is a diagram illustrating how a game may be implemented to attract players according to an embodiment of the present invention;

FIG. 14 is a block diagram of a system including a government skill site for fun through which sklot may be played, and the relationship of the skill site with other gaming features and sites, according to an embodiment of the present invention;

FIG. 15 is a block diagram of a system including a government skill site for cash through which sklot may be played, and the relationship of the skill site with other gaming features and sites, according to an embodiment of the present invention;

FIG. 16 is a block diagram of a system illustrating the integration of a sklot in a non-online gaming environment according to an embodiment of the present invention;

FIG. 17 is a block diagram illustrating the integration of sklot features in social networking environments and gaming environments according to an embodiment of the present invention; and

FIG. 18 illustrates aspects of the operation of converting players from other platforms to play for fun on the skill sklot according to an embodiment of the present invention.

### DETAILED DESCRIPTION

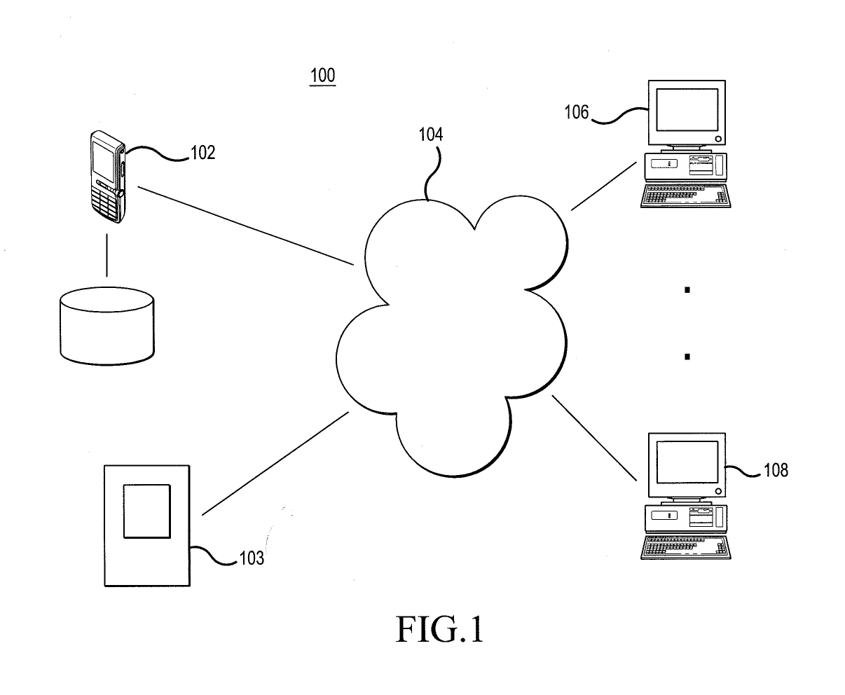

Aspects of the invention are more specifically set forth in the accompanying description with reference to the appended figures. FIG. 1 is a general block diagram of a system environment in which a sklot game may be played according to an embodiment of the present invention. The system architecture illustrated in FIG. 1 depicts an system environment in which systems, methods, apparatus, computer-readable mediums and data structures consistent with the principles of some embodiments of the present disclosure may be included. It may be appreciated that the components of system 100 may be implemented through any suitable combinations of hardware, software, and/or firmware.

As shown in FIG. 1, system 100 includes at least one server 102 and/or at least one gaming database 103. Server 102 and gaming database 103 may be communicably linked to one or more client devices 106, 108, etc. through network 104. The gaming database 103 may be any type of physical unit on which games reside, such as a machine in a gaming venue, a lottery machine, an electronic game system, etc. Network 104 may be implemented as the Internet, or any local or wide area network, either public or private. Network 104 may also be a hardware system physically connecting some or all of the server 102 and client devices 106, 108. Client devices may be implemented as any computing devices such as a personal computing device, a server, a server network, handheld computing device, slot machine, other gaming machine in a gaming venue, lottery machine, an interface in a virtual environment, etc.

It may be appreciated by one of ordinary skill in the art that while only one server, one gaming database, one network and two client devices are depicted, more or fewer servers, more or fewer gaming databases, more networks and more or fewer client devices and/or other devices may reside within system 100.

The elements inside system 100 may include one or more (micro)processors, purpose built hardware such as, for example, FPGA, ASIC, etc., software systems and applications, software packages, mechanical and electrical parts, etc. Software packages that may be part of server 102, gaming database 103, network 104 and client devices 106, 108 may be recorded on a computer readable medium such as a memory device, RAM, CD/DVD/USB drives, handheld memory device, etc., and/or may be part of a physical device such as one or more (micro)processors or electro-mechanical systems. Any of server 102, gaming database 103, network 104, and client devices 106, 108 may be fixed systems, mobile systems or portable systems.

Although the various components of FIG. 1 are illustrated as discrete elements, it should be recognized that certain operations of some of the various components may be performed by the same physical device, e.g., by one or more microprocessors or other type of devices.

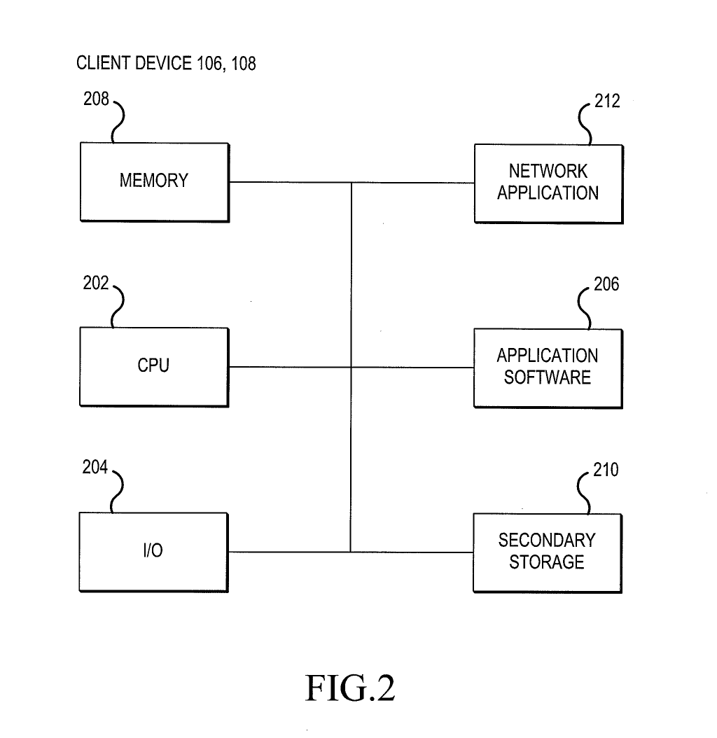

FIG. 2 is an exemplary block diagram illustrating components included in client device 106, 108 capable of playing a game such as sklot according to an embodiment of the present invention. Client device 106, 108 may include central processing unit 202, input/output devices 204, application software 206, memory 208, secondary storage 210, and network application 212. Client device 106, 108 may be communicably linked to servers 102 and/or gaming database 103 through network 104. It may be appreciated by one of ordinary skill in the art that while only certain components are depicted, other components may be included within client device 106, 108.

A player may access server 102 or gaming database 103 through network 104 using network application 212 wherein the application software may include a conventional browser including conventional browser applications available from Microsoft, Mozilla, Netscape, etc., or other software for connecting to an item/page/application package, etc. available on the network. Application software 206 may include software for facilitating creating a session between the client device and the server or gaming device in order to play sklot as discussed herein. Secondary storage 210 may be used to store information regarding one or more of: player information, game information such as preferences, score, etc., configuration for client device or server 102/gaming database 103/network 104, etc. Secondary storage 210 may include a computer readable medium such as a memory device, RAM, CD/DVD/USB drives, etc., and/or a unit on a physical device such as one or more (micro)processors.

Input/output devices 204 may include, for example, a keyboard, a mouse, a video cam, a display, a touch-screen display, a storage device, a printer, a portable recording medium, an electro-mechanical device, etc.

Although the various components of FIG. 2 are illustrated as discrete elements, such an illustration is for ease of explanation and it should be recognized that certain operations of the various components may be performed by the same physical device, e.g., by one or more microprocessors or devices. The various components of FIG. 2 may include one or more (micro)processors, purpose built hardware such as, for example, FPGA, ASIC, etc., software systems and applications, software packages, etc., as well as a computer readable medium such as a memory device, RAM, CD/DVD/USB drives, etc. storing software packages.

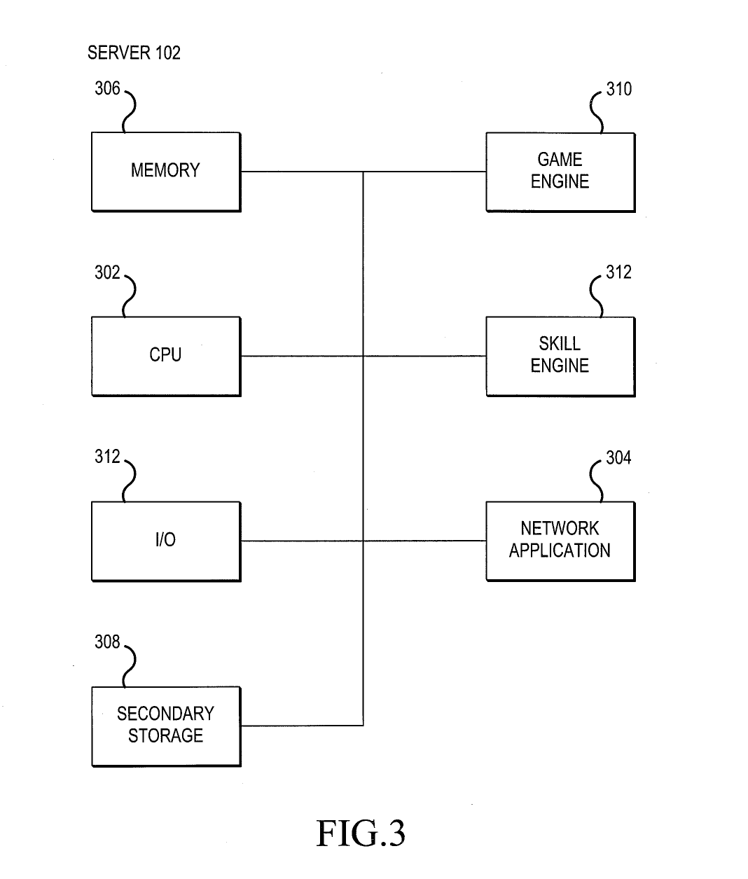

FIG. 3 depicts an exemplary block diagram of a server 102 that may be implemented in the system environment 100 in which a game may be played according to an embodiment of the present invention. As shown in FIG. 3, application server 102 include a CPU 302, network application 304, memory 306, secondary storage 308, input/output devices 312, a game engine 310 and skill engine 312.

Input/output devices 312 may include, for example, a keyboard, a mouse, a video cam, a display, a storage device, a printer, a portable recording medium, an electro-mechanical device, etc. Network application 304 may include software applications that facilitate communication with client devices 106, 108 through network 104. It may be appreciated by one of ordinary skill in the art that while only certain components are depicted, other components may be included within servers 102.

Game engine 310 may be implemented as a game server to facilitate establishing, maintaining and closing sessions with client device 106, 108 wherein the sklot game may be played. game engine 310 may further communicate with skill engine 312 in order to send and receive information regarding existing sessions of games. Game engine 310 may further implement the non-skill portion of the game.

Skill engine 312 may be implemented as a skill server to facilitate receiving information regarding an existing session, implement a skill portion of the sklot game and pass information regarding the results of the skill portion of the sklot game back to the slot engine 310.

It may be appreciated that the skill engine may be implemented to receive information regarding a skill game and parse the skill game down to one or more levels, parse a full version of the game down to a specified time period, etc., in order to implement a skill portion of the game. The parsed down version may appreciate all of the features of the full version of the game, except that only one or more levels are presented, the game is only played for a particular period of time, etc.

The skill engine may implement any skill game as the game played during the bonus round. Details of how the skill engine parses down a skill game is more thoroughly discussed in the process flow description below in relation to sklot.

Furthermore, while details of the methods, units and software applications are described in the present application in the context of slot games, the principles of the current invention apply equally to other games of chance besides slot games, whereby a skill game is triggered in a game of chance and players win money or other rewards based on their ability, as opposed to an outcome based on chance.

Although the various components of FIG. 3 are illustrated as discrete elements, it should be recognized that certain operations of some of the various components may be performed by the same physical device, e.g., by one or more microprocessors or other type of devices. Thus, it may be appreciated that the skill engine and the game engine may reside in or work from the same unit, computing device, or (micro)processor. The skill engine and the game engine may also be separate. For example, the skill engine and the game engine may reside on, or work from, separate computing devices, units or (micro)processors. It may further be appreciated that the game engine may communicate with more than one skill engine that resides within the same computing device or on different computing devices or remote servers operating within system environment 100. Also, the skill engine may communicate with more than one game engine that resides within the same computing device or on different computing devices or remote servers operating within system environment 100.

In an exemplary implementation, server 102 may be implemented as a Linux box. In one embodiment, the server 102 is a Linux box with 2 dual core CPUs with at least 3 GHz, 8 GB RAM and 140 GB hard drives in RAID. It may be appreciated that other configurations may be implemented providing the functionality discussed herein is achieved.

The gaming database 103 may similarly include a game engine and a skill engine. The game engine may be implemented as a slot machine application to facilitate establishing, maintaining and closing sessions with client device 106, 108 wherein the game may be played. The skill engine may be implemented as a skill server to facilitate receiving information regarding an existing session, implement a skill portion of the game and pass information regarding the results of the skill portion of the game back to the game engine. Alternatively, the game engine and/or the skill engine may be accessed directly by a player in a gaming venue. Game engine may further communicate with skill engine in order to send, receive and/or store information regarding existing sessions of games. Game engine may further implement the non-skill portion of the game. The gaming database 103 may be an electro-mechanical unit in a gaming venue and may include electronic components for communication with a network, and/or interface components to provide direct accessibility to players.

Sklots are slots, or other types of game of chance, with skill game bonus round(s). Players can practice games in a skill environment to boost their chances of winning. The games on skill environment may be a version of the game on the sklot bonus round. Other types of games may include poker, Bingo, word games, or any other game type.

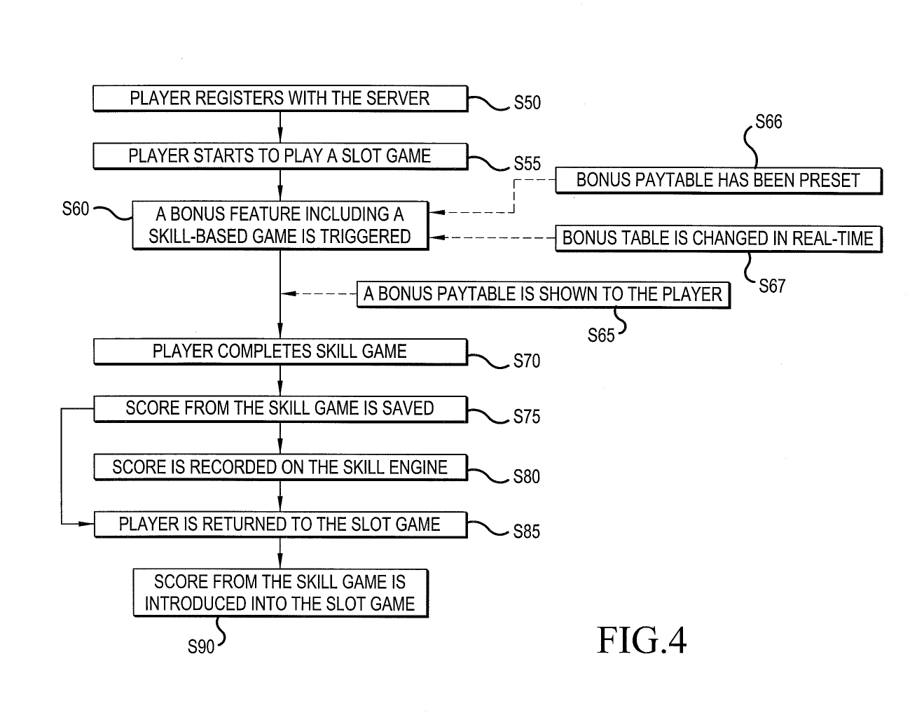

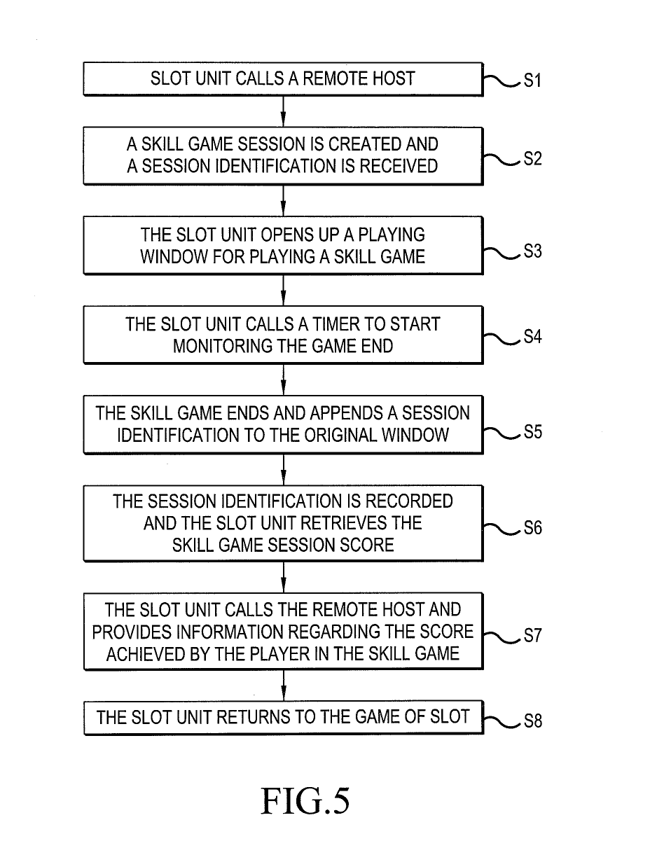

FIG. 4 is a flow diagram illustrating operations performed when playing sklot according to an embodiment of the present invention. To play sklot, a player may first register with the server 102 (S50). The player then starts to play a slot game (S55) by accessing the slot engine. When a predetermined scenario occurs in the slot game or upon some other trigger, a bonus feature including a skill-based game is triggered (S60). The skill-based game is associated with a bonus paytable which may be preset (S66) or may be changed in real-time (S67). The bonus paytable may, optionally, be shown to the player prior to the skill game starting (S65). In one embodiment, it is the player's choice when in the slot element to see the bonus paytable, or whether to see the bonus paytable within a relevant webpage, or whether to see the bonus playtable at all. In another embodiment, all paytables may be shown on screen during both or either parts of the games paytable, as is often shown in traditional slots.

Upon completion of the skill game by the player (S70), a score from the skill game which is determined based on player's skill and on the bonus table is saved (S75). The score may be recorded on the skill engine (S80). The player is then returned to the slot game (S85) and the score from the skill game is introduced into the slot game (S90) where it affects a gaming result in the slot game played by the player. For example, in an exemplary embodiment, at step S90 the score is received by the random-number-generator (RNG) game and matched to a predetermined payout table in the RNG game to define the winnings offered to the player from the skill round. The score could, in subsequent versions, also affect a gaming result in the slot game played by the player.

A sklot game includes one or more external game sessions which are obtained through a remote or local connection to a database, such as a web service from a 3rd party site or stored locally on the computing device. The sklot game is provided at the users computing device in a window such as an iframe and then the score may be reported back via a web service call. Some of the elements which may be part of a sklot game are the following:
the Intro, which may be a short flash movie introducing the game, and which may be served before the sklot loads;
the slot, which is a slot game;
a bonus feature, which is a skill game played as the bonus feature;
a slot paytable which includes multipliers relating to the core slot game;
a bonus paytable which is a multiplier for players score relating to the bonus feature;
active button(s)/instruction(s) within the slot section for launching pages showing the paytables and, optionally, the rules for the sklot and the bonus features; paytables and rules may both be shown based on this command, or only the paytables may be shown.

FIG. 5 is a flow diagram illustrating in mode detail a process flow of playing sklot according to an embodiment of the present invention. An exemplary general process for playing sklot includes the following steps. In step S1, a slot unit calls a remote host which is located on server 102 or gaming database 103, to request a bonus round to be started. The slot unit is a unit in communication with a client device 106, or located on client device 106. A slot game (also called “slot” herein) can be played through the slot unit. The slot unit may receive input from a player and may communicate with server 102 or gaming database 103.

In step S2, a skill game session is created and a session identification is received. In step S3, the slot unit opens up a playing window for playing a skill game, which is part of the bonus round. In step S4, the slot unit calls a timer to start monitoring the game end. At step S5, the skill game ends and appends a session identification to the original window. In step S6, the session identification is recorded and the slot unit retrieves the skill game session score. In step S7, the slot unit calls the remote host and provides information regarding the score achieved by the player in the skill game. The information sent in S7 may define, within the slot engine, the amount paid out (using, for example, a specified bonus paytable) to the player when the player returns to the slot. The slot unit may then return to the game of slot (step S8).

Exemplary details for steps S1-S8 are provided below.

In step S1, the slot unit may call a webservice. In an exemplary implementation, the sklot may use a SOAP (Simple Object Access Protocol) or other protocol with the web service to communicate with the skillgaming engine (the skill engine 312).

In step S2, a game session is created and a session identification is received. Also, when the sklot unit requests a bonus round to be started, a unique session id for the bonus round is created and provided.

In step S3, the slot unit opens up a playing window. The slot unit opens up the playing window from data received by the skillgaming site which may be controlled by server 102 or gaming database 103. The sklot may support any number of languages and a player may then be able to play sklot under a selected language.

In step S4, the slot calls a timer to start monitoring the skill game end.

At step S5, the game ends and appends a session identification to the original window.

In step S6, the session identification is recorded and the slot retrieves the session score.

In step S7, the slot calls the webservice again. For example, when the bonus round has finished, the bonus game calls a javascript running in the slot window which calls and receives a session id and invokes a server side function to retrieve the score of the bonus round achieved by the player.

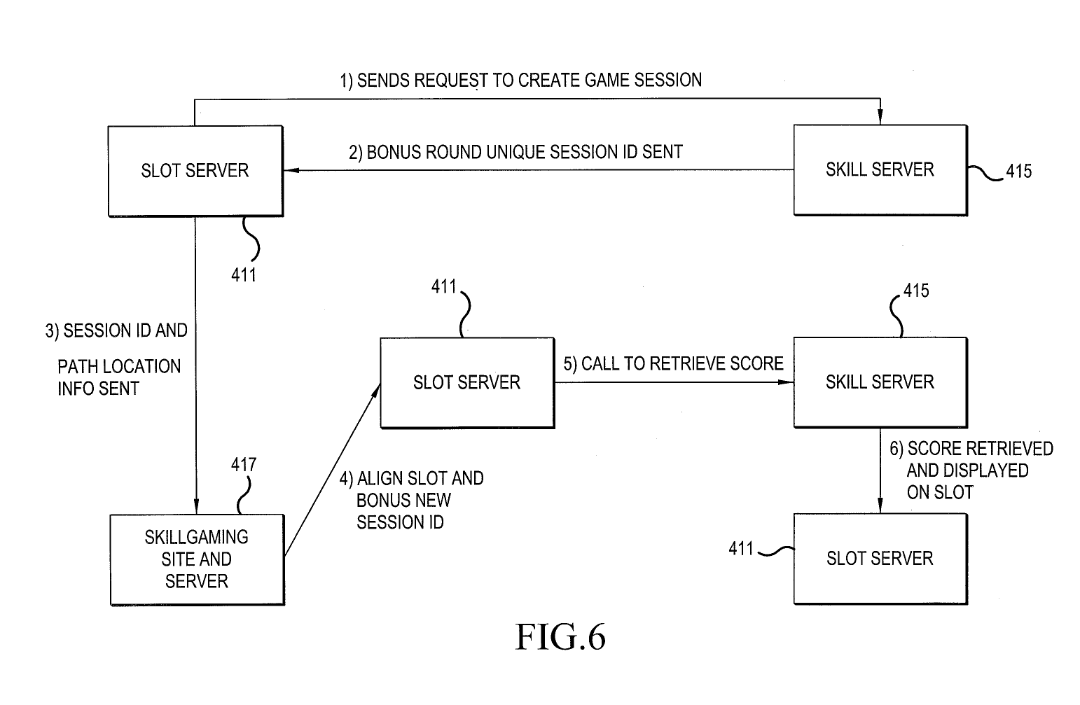

FIG. 6 is a block diagram illustrating in detail exemplary aspects of sklot including the exchange of information between a slot server 411, a skill server 415 and a skillgaming site and server 417 during a game of sklot when a bonus round is triggered, according to an embodiment of the present invention. As shown in FIG. 6, when a bonus round is triggered, the slot server sends a request for a skill game bonus session id to the skill server, which sends back the unique session id for the bonus round. The slot server 411 sends information pertaining to the slot game and path information where to retrieve the bonus round data to the skillgaming site and server. The skillgaming site and server sends information to align the bonus round with the slot game and provides a new session id to the slot server. The slot server then retrieves the score of the bonus round from the skill server. Finally, the score is retrieved and the payout received using this score and the bonus paytable is displayed on slot at the slot server.

It may be appreciated that various permutations are possible for the locations of the skill server, slot server and skillgaming site and server. For example, the skill server, the slot server and the skillgaming site and server may each be located at, or work from different online or physical locations, or may be located at, or work from the same online or physical location. The skill server and the slot server may also be located at, or work from, the same online or physical location which is different from the online or physical location of the skillgaming site and server. Also, the skill server and the skillgaming site and server may be located at, or work from the same online or physical location which is different from the online or physical location of the slot server. Other locations combinations for the skill server, slot server and skillgaming site and server are also possible.

In playing sklot the payouts may be determined by defined paytables. A game of sklot may use two paytables: a slot paytable which includes multipliers relating to the core slot game, and a bonus paytable which is a multiplier for players' scores in the bonus feature in which the skill sub-game is played.

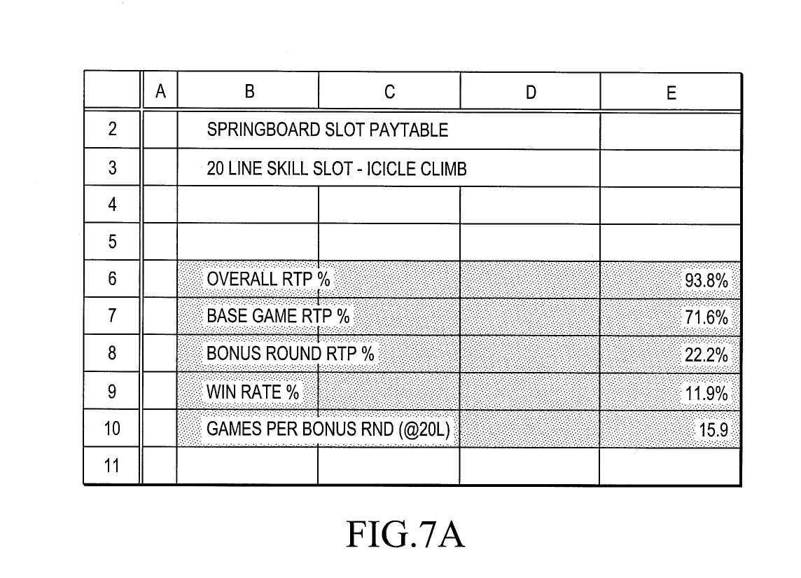

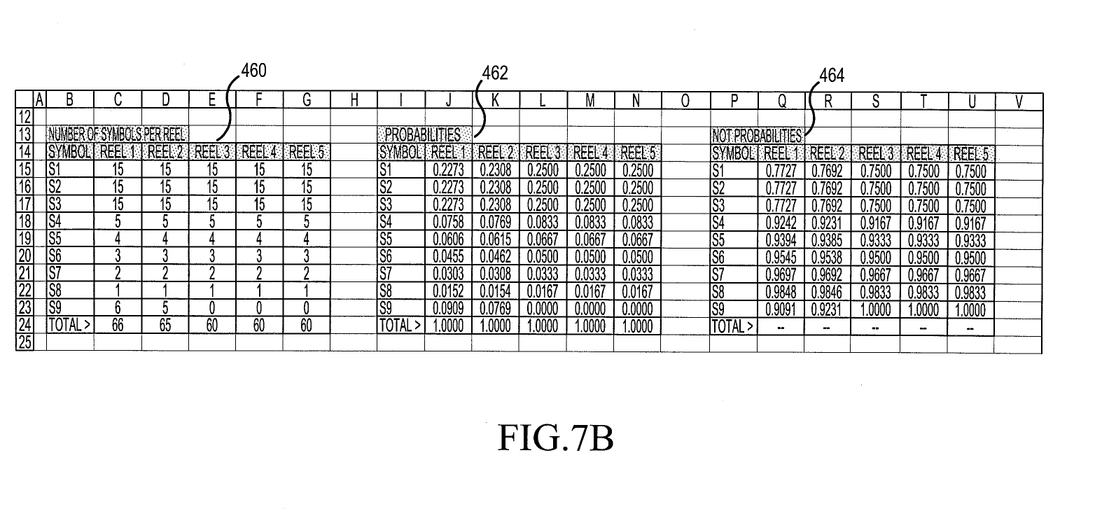

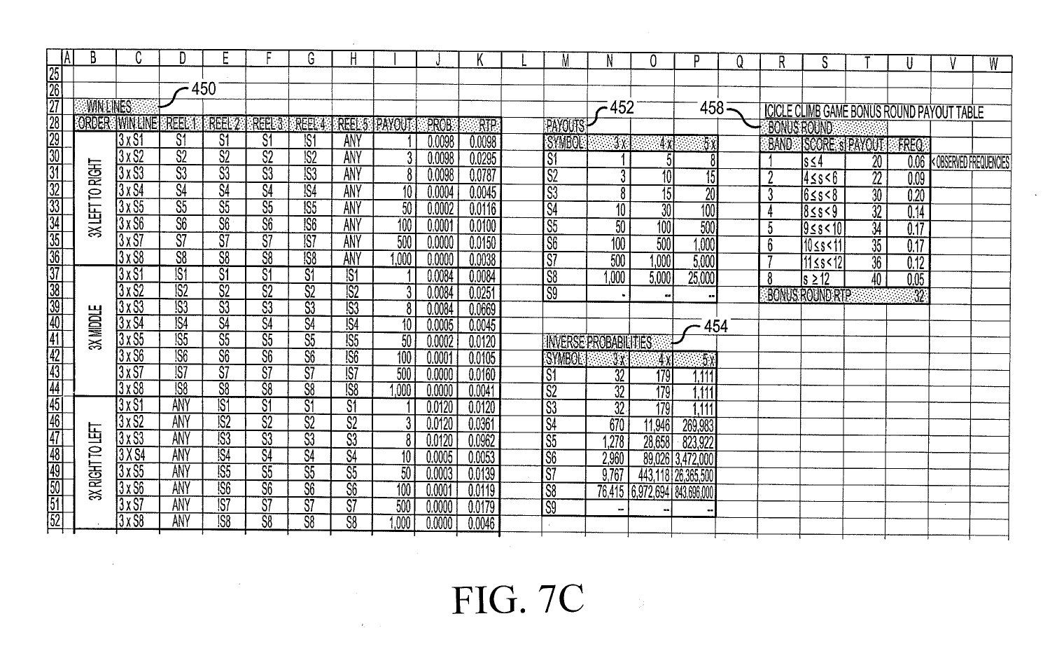

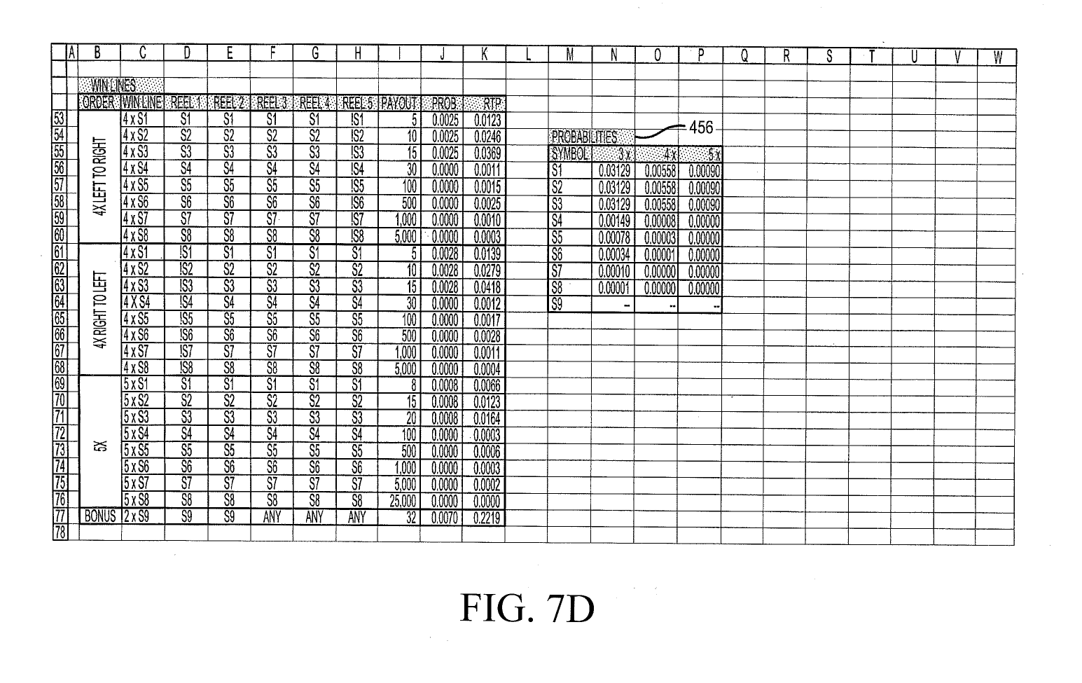

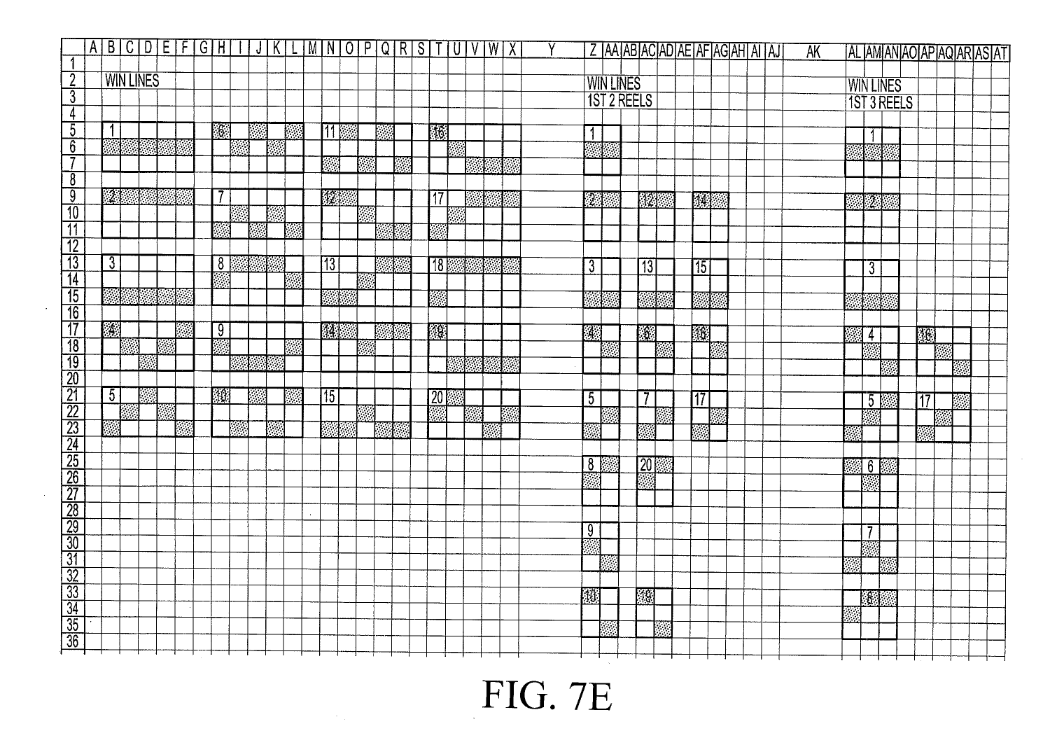

FIGS. 7A-7D illustrate exemplary details of a slot paytable and a bonus paytable for determining a player score in the bonus feature in which a skill sub-game is played according to an embodiment of the present invention. FIGS. 7A-7D are only exemplary and provide information regarding the slot paytable for the sklot game based on the “Icicle Climb” game. It may be appreciated that the information depicted in the slot and bonus paytables in FIGS. 7A-7D is provided as an example and the information may vary from game to game.

The information depicted in the slot paytable may be entered, managed, deleted, etc., in the slot engine. It may be appreciated that any applicable software applications may be used to enter and manage this information. It may further be appreciated that this information may be provided for each of the skill games incorporated within the system. Further, the information as depicted in the figure is provided as an example and may vary based on desired Return To Player (RTP), the skill game that is played, etc.

Section 450 in FIG. 7C essentially defines an exemplary core slot table, while section 452 provides a neatened summary. Thus, at a base level, sections 450 and 452 of FIG. 7C are the data that may be used to define a slot paytable. The paytables and associate information shown in FIGS. 7A-7D are only exemplary, and more than one core slot paytable, including different features, may be present in the slot game. Also, more than one core slot paytable may be used in the derivation of one or more bonus paytables for the same or for multiple skill games within the slot game.

FIG. 7D illustrates the win lines for the core Icicle Climb slot game. FIGS. 7A, 7B and 7C illustrate bonus paytables determined based on win lines and probabilities of appearances of symbols, as explained in more detail below.

The RTP percentages in FIG. 7A are calculated using probabilities shown in FIGS. 7B and 7C In an exemplary payout set-up, payouts may be modeled based on desired payouts expected from standard slots on the market, which are then modified to achieve a similar payout system using the skill game and the observed frequencies. Taking into account that the skill game may be perceived as the most exciting and fun part of the sklot game, the bonus round may be modeled to appear frequently. In one exemplary implementation of sklot, the bonus round appears on an average of 15.9 spins if players had selected all 20 lines of the slot. The bonus paytables defining the skill game scores are built based on formulas and methods used to calculate pay amounts for players. The Overall Return to Player (RTP) % is the Base Game RTP %+Bonus Round RTP %.

The Base Game RTP % is the sum of the value of fields K29 to K76 as depicted in the Win Lines table 450 in FIG. 7C. This value represents the percentage of the overall value returned to the player during the base round portion of the core slot game.

The Bonus Round RTP % is the value of K77 field depicted in K77. This value represents the percentage of the overall value returned to the player during the bonus round portion of the game.

The Win Rate is the sum of the value of fields J29 to J77 in the Win

Lines table. This value represents, for each line, the percentage of times the player would win any particular amount in the slot, non-skill portion of the game.

The Games per Bonus Round, calculated at 20 lines, is (1/J77)/9, where J77 is depicted in the Win Lines table. For example, if the player selected all 20 lines, on average, the player would advance to the bonus round once every 16 spins.

The Number of Symbols per Reel table 460, Probabilities table 462, Not Probabilities table 464, Win Lines table 450, Payouts table 452, Probabilities table 456 and Inverse Probabilities table 454 (FIGS. 7A-7C) may be implemented during the non-skill, slot portion of the game. The slot engine may utilize a random number generator in order to generate a symbol for each reel for each line selected by a player and payout in accordance with the values in these tables. The Bonus Round table 458 may be implemented during the skill portion of the game.

Additional details regarding specific features in the tables in FIGS. 7A-7C are provided below.

Number of Symbols per Reel table 460 (FIG. 7B) depicts how often each of symbols S1 through S9 appears on each of Reel 1 through Reel 5. S9 as depicted in all of the tables may be implemented as the bonus symbol (the bonus feature trigger). S1 through S3 may be implemented as low payout symbols, as shown in the “Payouts” table in FIG. 7C. As such, they may appear more frequently. The frequent appearance of these symbols is associated with payment of lots of small prizes.

In contrast, S7 through S9 may be implemented as high payout symbols. Thus, they appear less frequently. S9 may only appear on two reels, for example, Reel 1 and Reel 2. The numbers of symbols per reel are used to calculate how often the bonus features can appear.

Probabilities table 462 (FIG. 7B) depicts the probability of a particular symbol appearing on a reel. The probability of, for example, S1 appearing on Reel 1 may be calculated based on the corresponding values in the Number of Symbols per Reel table 460. Similarly the probabilities of the other values in the Probabilities table 462 may be calculated based on the corresponding values in the Number of Symbols per Reel table 460.

Not Probabilities table 464 (FIG. 7B) depicts the probability of a particular symbol not appearing on a reel. The probability of, for example, S1 not appearing on Reel 1 may be calculated based on the corresponding values in the Probabilities table 462. Similarly the probabilities of the other values in the Not Probabilities table 464 may be calculated based on the corresponding values in the Probabilities table 462.

The Win Lines 450 (FIG. 7C) show the actual symbols on each of the virtual reels used for the slot calculation. These Win Lines 450 distributions and the amounts of bonus symbols shown in Number of Symbols per Reel 460 (FIG. 7B) together with the Probabilities 456 (FIG. 7C) define the payouts shown in the Payouts 452 table in FIG. 7C.

The Win Lines table 450 includes the payout, probability of occurrence, and return to player based on the different combinations of symbols appearing on each of the reels. For example, G29 will win if S1 appears on R1, R2 and R3, any symbol other than S1 appears on R4 and any symbol appears on R5.

Similarly the payout, probability and RTP in the Win Lines table 450 may be calculated based on the corresponding values. The first column “Order” in the win lines table 450 (FIG. 7C) depicts information relating to the order of the winning combinations. For example, “3× Left to Right” provides information regarding payout, probability and RTP for three matching symbols appearing left to right on Reels 1, 2 and 3, any symbol on Reel 5 and the matched symbol not appearing on Reel 4.

The paytable has been split to break down the RTP on each section of the slot. The rows are split in subgroups such as 3 on the left column, the 3 in the middle then the 3 in the left columns, 4 on the left and 4 on the right. “3 Right to left” means 3 symbols from the right.

As can be seen from the last row in the Win Lines table 450, if symbol S9 appears on Reel 1 and Reel 2, regardless of the symbols that appear on Reels 3-5, the player advances to the bonus round.

The Payouts table 452 (FIG. 7C) represents the multiplier of the payout the player may receive. The values in this table affect the Base Game RTP. For example, if S1 appears 3 times (in the Order column in the Win Lines, “3× Left to Right”, “3× Middle”, or “3× Right to Left”) in the Win Lines table 450, the player will be paid 1× payout amount. If the symbol S4 appears 4 times (in the Order column in the Win Lines, “3× Left to Right”, “3× Middle”, or “3× Right to Left”) in the Win Lines table 450, the player will be paid 30× payout amount.

S9 represents when the player enters the bonus round and will be discussed in the Bonus Round table 458. In order to receive the bonus feature at least 2 bonus symbols must appear on a single win line. However, the trigger for the bonus round may be any number greater than 2 up to the number of symbols represented on a single line, for example, 3, 4 or 5 etc. The frequency of their appearance defines how often the bonus feature appears. As discussed with regard to the payout during the base portion of the game, the payout to the player is random based on a random number generator generating which symbols appear on each reel. However, the payout in the Bonus Round table 458 (FIG. 7C) is directly related to the skill of the player playing the bonus round.

The Bonus Round table 458 shows the relationship between the score achieved in the bonus round, a related score band and the payout multiplier of the stake related to each score and how much it pays in the base slot game. The frequencies column shows the observed frequencies from the statistical data of real play of the bonus feature game. This allows estimating the spread of score that will be achieved by real players on the game.

The Bonus Round table 458 includes four columns, band, scores, payout and frequency. All of the possible scores are divided into eight score bands as depicted in the band column. The score column depicts the range of scores for each of the score bands. The payout column depicts the multiplier of the payout the player may receive for each of the bands. The frequency represents how frequently a player may score with respect to each band.

Since this exemplary game is a game of skill, there is no random element and frequencies depend on game play. Slot frequencies are determined by the likelihood of achieving a result according to the symbols and paytables. The use of frequency in this illustration relates to observed frequencies. Using statistical data (in this case 60,000 plays of the game), payouts were observed and used as an example of potential frequencies to guide the creation of the paytable. In this example, the actual results would be determined purely by the skill of the players playing the bonus round.

For any new skill game that is parsed and made a part of the skill portion of the sklot game, the system as discussed herein may determine and store information as statistics for each game that is played. For example, for each session where the skill portion of the game (the bonus portion) is played, the slot server may monitor and store the score that is achieved. Once a predetermined number of games are played, the system may determine the bands of the scores for a skill portion of the game based on an optimal frequency for each of the bands, i.e., using the observed frequencies from statistical data in order to distribute payouts.

It may further be appreciated that the score bands may be automatically adjusted. For example, once the bands are established, the system may continue to monitor the result of each skill game that is played. If the actual frequency exceeds the expected frequency beyond a predetermined threshold, the scores for one or more bands may be adjusted so that the optimal frequency may be achieved. Alternatively, instead of changing the score to achieve the optimal frequency, the payout amount for one or more bands may be changed in order to conform to a predetermined RTP.

Using this game and paytable as an example, it may be appreciated that once a player enters the bonus round, the overall RTP may be between 85.6% and 99.6%, based on the values depicted in the tables, taking into account how often the bonus feature appears. However, these percentages may vary. The maximum payout if all players achieved the maximum scores is not greater than 100%, but using the observed frequencies, the expected payout is expected to be around 93.8%. This percentage, however, may be lesser or greater.

The win rate is high, giving players the feeling of constant wins. 11.9% allows players to receive some kind of win (however small) on most spins of 20 reels.

When more skill games are added to the core slot engine, the score within the Bonus Round table in FIG. 7C is adjusted in order to spread the scores of any skill game to match the paytable. The payouts can be adjusted on the fly by decreasing the amount paid out on the bonus round per score band or increasing them. The maximum payout on the highest pay band may be fixed to ensure that the theoretical RTP is always under 100%.

The probabilities table (FIG. 7C) depicts the probability of receiving the different combination of symbols as set forth in the Win Lines table 450.

The inverse probabilities table 454 (FIG. 7C) depicts the inverse of the probability of receiving the different combination of symbols as set forth in the Win Lines table.

As described previously, sklot is a slot with a unique bonus feature, instead of playing a random draw or probability payout bonus feature. The sklot bonus round is a skill game. The results achieved by the player in this round define the size of the player's payout in the bonus feature, so that the better the player plays, the more the game pays. Because Sklot includes engaging skill games bonus features, it may increase the repeat playability and extend the enjoyment of the user/player.

Exemplary sklots may integrate line slots and skill games within the game bonus feature. In an exemplary implementation, the line slots are standard line slots. One novel feature of sklot is that successful play on the bonus feature affects players' payouts. This encourages repeat play on the games and the sklots.

Multiple game engine versions are available to the player. One exemplary implemented Sklot is a 5-line Click and Clear. Another exemplary Sklot is a 20 line Sklot (e.g., the “Icicle Climb” mentioned above). The combination of soft recognizable games within a high quality 20 line Sklot is unique in the game world and is revolutionary in the way players interact with slots. Additional game features such as Wild Cards, Multiplier Symbols and Free Spins may be available in a Sklot game. These features are available in many standard slot games and could appear within the slot section of any Sklot. Sklots with such new game features may also implement different paytables and RTPs.

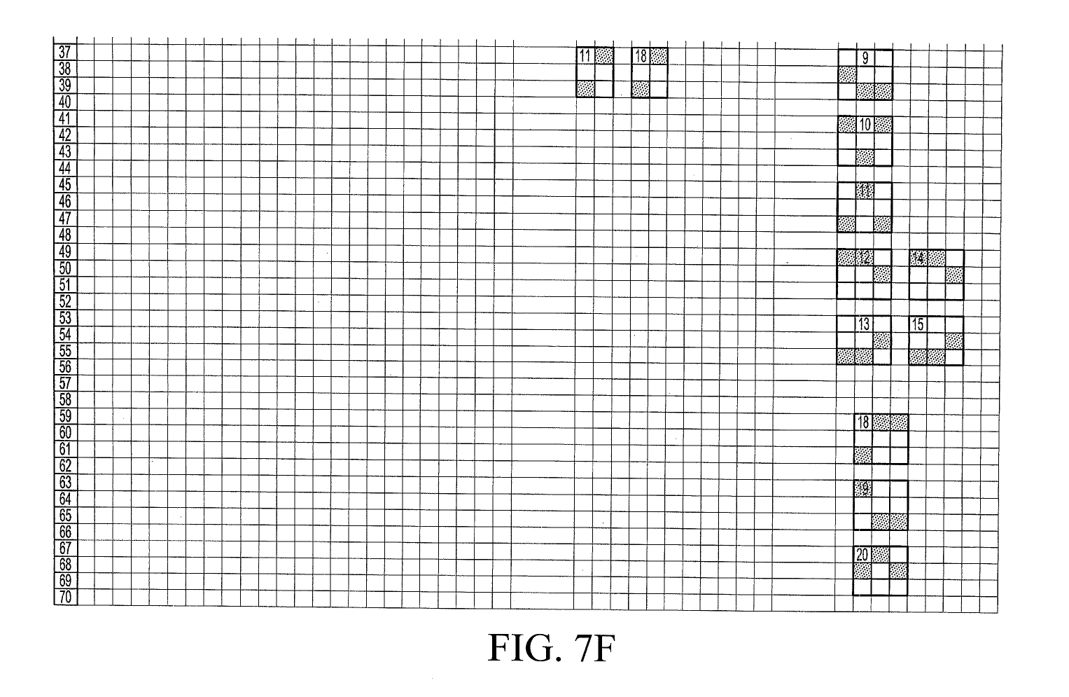

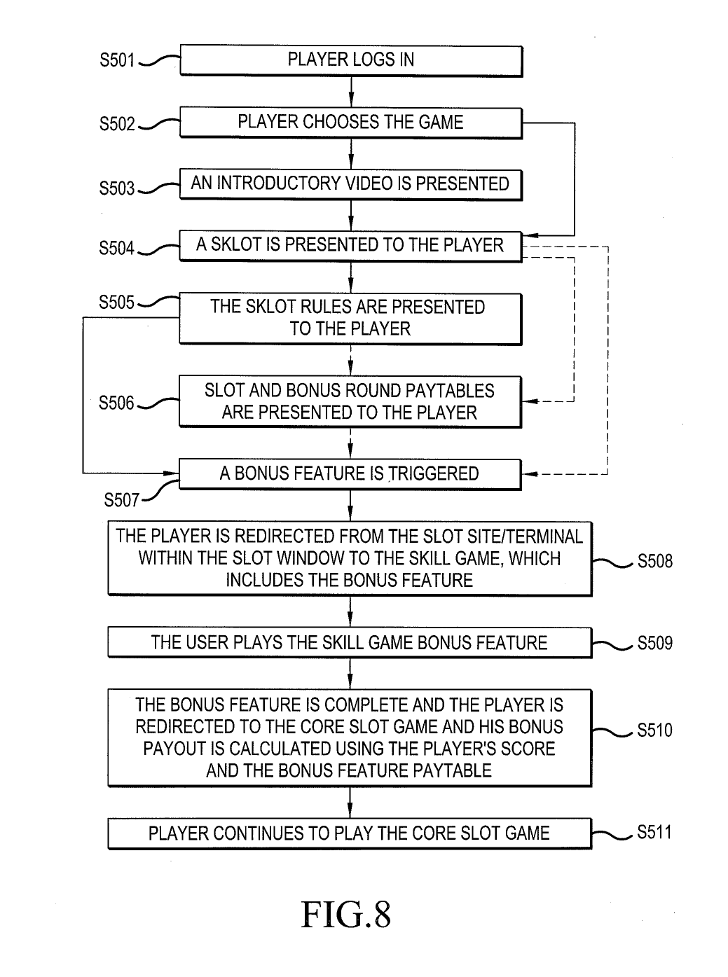

FIG. 8 is a flow diagram illustrating exemplary steps in a play of sklot according to an embodiment of the present invention. An exemplary process flow of playing Sklot includes the following steps. Step S501 is a log in step, at which a player goes to the website and enters their username and password to log in, however a player may not have to enter a username and password in some instances and environments. In a licensed venue a player could activate the game by coin entry instead of login. At step S502 the player chooses the game. The player can select the sklot game from the list of games available by clicking the play button.

At step S503 an introductory video may be presented, if desired by the player. Sklot games may be preceded by the introductory video which explains the features and benefits of playing a sklot. The introductory video also serves as an intuitive explanation of how to play a section. Players can also skip the video using the skip button. Sklots may also launch without this feature, whereas some may have the feature outside of this flow as a separate how to play tutorial.

At step S504, a sklot is presented to the player. While a standard slot machine bonus round is a bonus round triggered with a Random Number Generator (RNG) payout, an exemplary sklot is a standard slot with a bonus feature where the outcome/payout is determined by a player's skill.

In an exemplary embodiment, an accumulation process may trigger a bonus round. For example, a player can collect special symbols that appear on each reel across the RNG (random number generator-based) game that they play. Once a combination of special symbols has been collected, the bonus round is triggered. In another embodiment, the trigger for the bonus round may be based solely on an RNG outcome from the base slot game. In yet another embodiment, the trigger for the bonus round may be determined by player's current score on the core (standard) slot game; or the trigger for the bonus round may be determined by both of these functionalities (RNG and player's previous score in the core slot game) which can be combined to trigger the sklot bonus round. In another embodiment, the score in one bonus round may help the player get another bonus round later.

The functionality of a sklot before the bonus round may be implemented, in an exemplary embodiment, to be substantially the same as a standard slot machine, and standard options, such as selecting lines, stake, maximum bet and spin may all be available as with a standard slot.

At step S505, the sklot rules may be presented to the player. The player may click to clear the screens. Players may also view the paytables on a separate webpage or in some cases during the game in parallel. At step S506, game paytables may be presented to the player.

As previously explained, there are two kinds of paytables: slot paytables and bonus round paytables. The slot paytable may be the same as a standard slot paytable, with each symbol having a set stake multiplier if it appears repeatedly in a selected pay-line. The bonus paytable illustrates the stake multiplier achieved using the scores received on a game of skill. Achieving a score on the skill game between certain score bands will give different multipliers to a player's stake per line. Regarding the above-mentioned multiplier, an exemplary embodiment implements the following functionality. Once a player has played the bonus round, the score which they earned is matched to a particular band as specified in the bonus round paytable. The multiplier is then applied to the line stake of the spin (in the core slot game) that triggered the bonus round, and the final figure is determined. In another exemplary embodiment (for phase 2 sklots), line multipliers may be included as well. This means that if the sklot bonus round is triggered on one or more lines then there will be an additional multiplier applied based on the amount of lines the bonus round was triggered on.

In another embodiment, the bonus paytable may depend on the bonus round, and different bonus paytables may be available for the first, second, third bonus round, etc. The bonus paytable(s) details may then depend on the amount of bonus symbols that occur to trigger the bonus round. In an exemplary embodiment (for phase 2 sklots), there can be 2-5 bonus symbols triggering a bonus round, with two providing the smallest additional multipliers and 5 providing the largest multipliers.

The bonus paytable may, for example, be shown to the player within a site page a player views based on the game and/or may also be found in a tab within the sklot itself. Players may choose to view this paytable when they wish, at any time within the RNG slot game. At step S507 a bonus feature is triggered. The bonus feature may be triggered, in an exemplary implementation, once the required feature symbols are triggered on a winning selected pay-line.

At step S508, the player is redirected from the slot site/terminal within the slot window to the skill game, which includes the bonus feature.

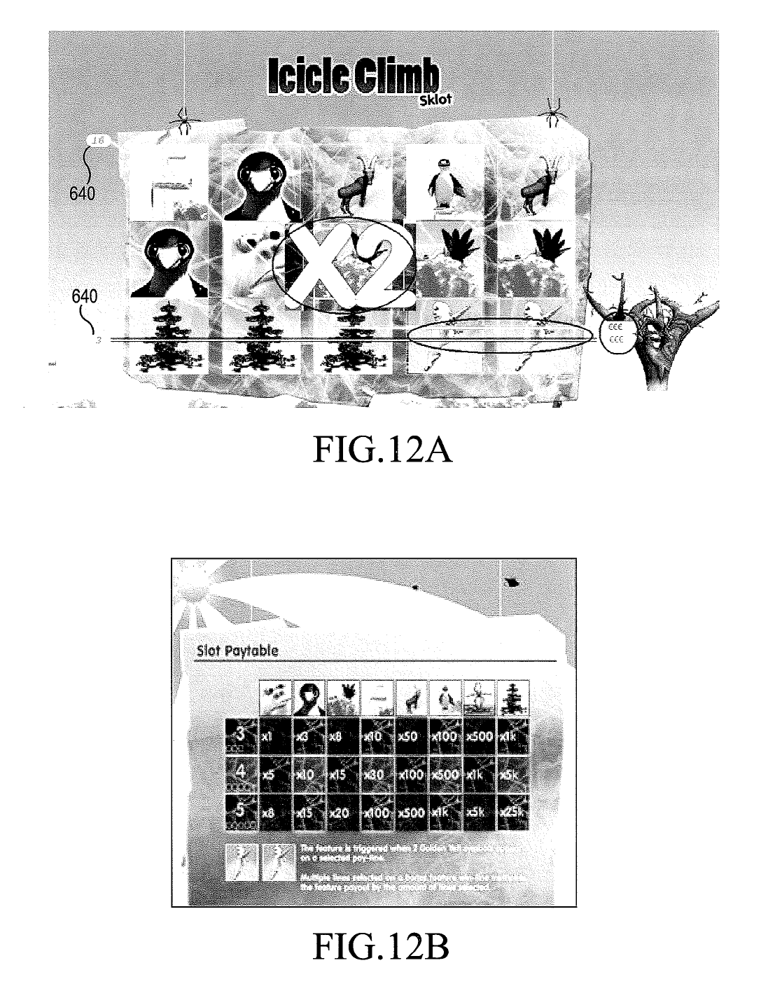

At step S509, the user plays the skill game bonus feature. In one embodiment, the score achieved by the user may be based solely on the user's skill, and there would be no RNG element within the feature game. In another embodiment, the score achieved by the user in the bonus round may be based on a mix of both user's skill and an RNG element from the core slot game or from the bonus round game. For example, an RNG element can be that a player receives 2 or more bonus symbols to trigger the bonus round. Payout will be increased if the player receives more than two. FIG. 12B illustrates such an exemplary payout table for an Icicle Climb bonus round.

Players are paid out as per the bonus paytable. The bonus features may have predefined set time limits to increase tension and insure a level playing field for people playing the same game. Once the time limits have elapsed the play in the bonus round ends. At step S510, the bonus feature is complete and the player is redirected to the core slot game and his bonus payout is calculated using the player's score and the bonus feature paytable. The bonus feature winnings are displayed on slot. The player can then continue to play the sklot, by playing the core slot game and potentially other bonus rounds (S511).

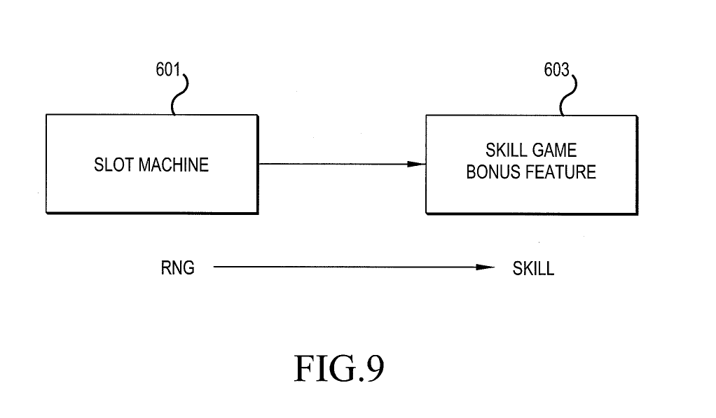

FIG. 9 is a block diagram illustrating a set-up of a sklot game according to an embodiment of the present invention. As shown in FIG. 9, a Sklot may include a slot machine 601 which includes a Random Number Generator (RNG), and a skill game bonus feature unit 603 for which the outcome/payout is determined by a player's skill. The sklot mechanics can be offered as free play or cash play.

Free play sklots may offer cash and/or prizes in the bonus feature, with payouts and prize values increasing as per players' scores. Cash sklots bonuses may be calculated, in an exemplary embodiment, by multiplying the players' line stake in the slot core game and the bonus multiplier determined by the players' score in the skill game multiplied by the amount of pay lines selected where the appropriate feature symbols appear in the core slot game. A bet per line may thus be paid out.

In an exemplary embodiment, for cash players, triggering the bonus round may require for example 2 or more feature symbols on a winning payline, and more symbols can payout higher multipliers, for example:
5× feature symbol=>paytable with a maximum payout of 100,000× stake multiplier;
4× feature symbol=>paytable with a maximum payout of 10,000× stake multiplier;
3× feature symbol=>paytable with a maximum payout of 100× stake multiplier;
2× feature symbol=>paytable with a maximum payout of 10× stake multiplier.

These multipliers apply to the maximum payout based on the score band the player's final score entered in the bonus round.

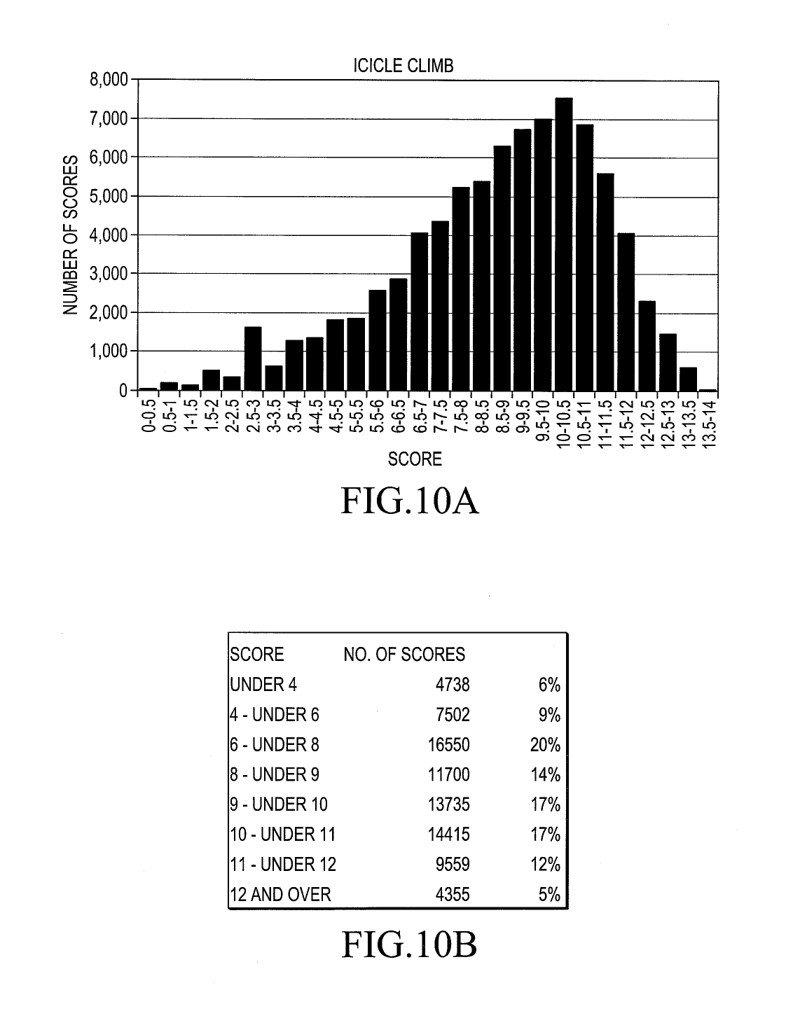

Score bands may be determined for each game based on the results of game played. For example, the score bands may be determined based on the results of collective play of all users for the game. In an exemplary embodiment, the score bands were determined based on ˜60,000 games on the Icicle Climb game (see FIG. 10A). The score bands can alter based on further game play analysis, if it is found that the RTP is greatly larger than the predicted RTP that has been defined.

When playing for fun, players could win cash based on promotional offers or competitions. The same relationship will apply so that having more feature symbols on a pay line causes a larger prize to be won. Fun play sklots which have one stake may offer cash prizes. For example:
5× feature symbols=$10 k-$50 k
4× feature symbols=$2 k-$10 k
3× feature symbols=$100-$2 k
2× feature symbols=$5-$100
where values are based on the score the player achieves in the bonus feature game.

Feature payout multipliers may be determined based on distributions of scores from a large number of plays on the skill game. FIG. 10A illustrates an exemplary histogram showing the results and distribution achieved from over 60,000 plays on the icicle climb skill game FIG. 10B illustrates the percentage of scores within certain ranges in FIG. 10A. Data such as these tables may been pulled from the Sklot bonus features to show the distributions of scores. The observed data helps determine the feature payout multipliers, as it can determine which percentile of scores are likely to be paid out on average. This data may be used to determine multipliers.

### Application Programming Interface for Sklot Game Configuration and Customisation

The exemplary Application Programming Interface (API) for sklot presented below provides game configuration and customisation, so that a section of the full game can be provided as the bonus round.

### A. API Container

The sklot bonus feature content may be created in a container with configurable elements. These elements can be changed easily and adapted per partner providing the core slot game or per version of a sklot. Part or an adaptation of any skill game that has been integrated into the skill game platform can be used as part of the bonus feature.

### B. Game Configurations for the API Container

The level choice is a certain level or section of the game that can be used as the bonus feature as opposed to the core game narrative. A round choice in a game where a player has multiple chances, and a configurable amount of chances that can be used for the bonus round. For example, in a baseball game, players could be given 3 chances to hit a ball, 3 bats with 3 chances each or a similar configuration. The game length is the maximum length of the bonus feature to be configured, which is especially important for games that have no specific ending and players continue to accrue points until the time is set to complete.

### C. Paytable Configurations

The system can easily change the payouts to the entire sklot by adapting the paytables of the skill game. Whereas changing the slot section payout may take time and considerable testing to determine probability changes in the frequency of reel symbols, the bonus feature can be changed easily in an instant.

Variables for paytable configurations include:
Paybands—the amount of different paybands relating to scores can be changed;
Scores in bands—the scores that relate to a stake multiplier can be adjusted;
Multiplier changes—the multipliers in each band can be adjusted, also, the minimum and maximum multiplier can be changed, which will directly affect the sklots Return to Player (RTP) value;

As long as the maximum multiplier is not increased, the sklot configurer system may ensure the maximum payout in the bonus skill game without any balancing changes necessary within the core slot game. Thus, changes made to the bonus paytable would not affect an instance of the slot section of the Sklot. The bonus skill game paytable and the core slot game paytable may therefore be independent entities working together, and balancing between the two is not necessary.

D. Implementing a with a Third Party

Scores may also be obtained from a third party. For example, the core slot game can have all probabilities and non-probabilities used to create the core slot paytable, created by a third party. The scores from the skill game can also be drawn from a third party as long as the scores are relevant to the game which has been modified to fit into the sklot.

This can be achieved, in an exemplary implementation, by the third party developer implementing a container similar to the one used on the skillgaming server and adding a webservice reporting the score of the implemented game(s).

### E. Alternative Implementations

One alternative implementation is integration of the skillgaming engine/server into the slot server. With this implementation, the slot may work as a standalone without calling the skillgaming server to start a game session and getting the score via a webservice call to the skillgaming engine.

### F. Sklot Tournaments

The skill games platform may include a tournament engine that allows the scores of skill games to be used in a variety of different tournaments and matches.

The summary of an exemplary sklot tournament would be that players pay an entry fee to start the tournament. They are then distributed with a set amount of “chips” or credits to be used on the sklot game. All players receive the same amount of currency and will play the same sklot machine. The winner can be determined by one of two or more outcomes, for example, by providing two tournament types and outcomes. The first outcome would be: “the player who has the highest balance after a set time period.” The second outcome would be: “the player who has the highest balance after a set amount of spins OR after a set time period.”

Players may be allowed to play on whatever stake they want to and as the outcome of the slot is random, they would all receive bonus rounds on different spins and at different times. Players can thus affect the outcome by performing well on the bonus feature.

The bonus feature of the sklot may have an identical scoring system to the skill games and therefore scores from the bonus feature can be used in any manner of competitions. As an example, all scores within a specified time period can be collated into a leaderboard table showing the top players of the bonus feature and can also payout prizes to players competing in the tournaments. To determine fair play, while it may be hard to predict the outcome of when and where players will receive their bonus round, the bonus round “seedings” may be set to ensure all players will receive the exact same version of the bonus round the first, second, third, etc. times that they trigger the bonus round. As an exemplary illustration, every first bonus round triggered may be game seed 1234, the second game seed may be 2345 and the third game seed may be 3456 and all players who trigger bonus rounds would receive them in that order.

### G. Exemplary Flash Variables for Sklots

Sklots may be implemented using various Flash variables. For example, Sklots may use different logic for the games, and often for the special bonus round features.

Sklots may run for a predetermined time frame. In one exemplary embodiment, all sklots run for 60 seconds. The host may also change its size to accommodate to the actual game size.

### H. Supporting Technology for Sklots and Skillgame Engine/Server

In exemplary implementations, webpages are written in ASP.NET, the code behind the game is written C#, the supporting framework is Microsoft.NET, and the DataBase is Microsoft SQLServer.

### I. Exemplary Server Hardware

An exemplary server hardware for the skill game server uses Windows and Intel servers. For example, a Windows Server® Standard of Microsoft Corporation (2007, Service Pack 1) and a Dell system, Server R300, Intel® Xeon® CPU—X3323 @ 2.50 GHz 2.50 GHz, with 4.00 GB RAM memory, and a 64-bit Operating System may be used.

Other operating systems and processors may also be used.

### J. Exemplary Slot Game Server

In a preferred exemplary implementation, a Linux box with 2 Dual core CPUs around 3 GHz, 8 GB RAM and 140 GB Hard Drives in RAID is used for the slot game server. The system may additionally or alternatively include one or more applications servers and one or more database servers which may have a setup similar to the applications servers, or different from the applications servers. The setup of the applications servers and database servers may also be similar to the setup for the skillgame server.

In an exemplary implementation, the system additionally or alternatively includes 2 application servers with the setup of Windows Server® Standard of Microsoft Corporation (2007, Service Pack 1) and a Dell system, Server R300, Intel® Xeon® CPU—X3323 @ 2.50 GHz 2.50 GHz, with 4.00 GB RAM memory, and a 64-bit Operating System on each, and 1 database server with the same setup. Exemplary Visual Interface for Sklot

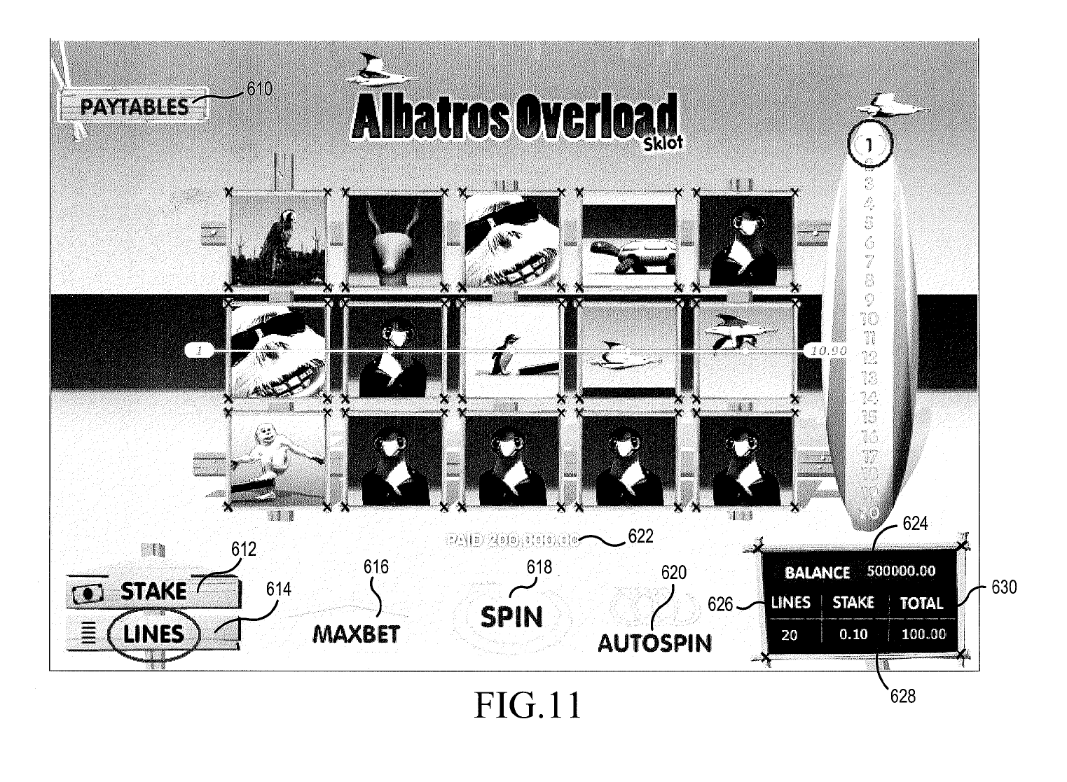

FIG. 11 illustrates a screen shot showing functional buttons in an exemplary sklot game according to an embodiment of the present invention. In FIG. 11, the functional buttons (from left to right) are used to perform the following functions:
PAYTABLES 610 button launches the paytables section showing players what they can win on the slot and on the bonus feature; all payouts relate to the amount staked per line; game rules and information also appear in this section;
STAKE 612 button defines the amount placed on a single line;
LINES 614 button selects the amounts of paylines chosen by the player; for example, in FIG. 11, the player has chosen only I line where the only win combinations appear when the reels stop on the centre line; players can select or deselect individual lines by clicking the number button linked to the paytable, which, in this example, are the numbers on the surfboard in FIG. 11;
MAXBET 616 button activates the maximum amount of lines and stakes available in the slot;
SPIN 618 button spins all 5 reels;
AUTOSPIN 620 button opens a submenu allowing the player to choose 5, 10 or 20 autospins.

Clicking one of the numbers on the AUTOSPIN 620 submenu automates that amount of plays without further clicking the Spin button 618. If a player enters the bonus feature during autospin, the player resumes the autospins automatically after confirming the bonus feature win amount.

While the autospins playout the amount of remaining spins decrease after every spin until the button changes from being an AUTOSPIN 620 button to a STOP button (not shown) that stops after the last spin. This mechanism does not affect the reels that are spinning, as it only stops the automated spins.

The labels in the small subscreen at the lower right in the screen shown in FIG. 11 indicate the following:
PAID 622, which shows the entire amount won in during the previous spin; this value appears immediately upon completion of the spin regardless of the individual paylines animation each win;
BALANCE 624, which is the player's account balance, updated immediately after each spin, regardless of payline animations;
LINES 626: amount of paylines chosen by the player;
STAKE 628: amount bet of each payline;
TOTAL 630: amount of LINES multiplied by STAKE 628, i.e. the amount staked on each spin.

The screens of sklot may also include animations which may be associated with buttons and labels and designed to create the feeling of movement.

Win lines may also include animations. The animations of each win line may be shown consecutively, immediately one after another, starting from the highest value win to the lowest. Players can click on a spin button immediately without watching the animations and continue to play, which does not affect the amount of spins on the AUTOSPIN 620 count, it simply speeds up the process by moving to the next spin.

Standard sklot features like free spins, multipliers and Wild Cards may be integrated into the sklot environments. A Wild Card is a symbol which can appear on any reel or set reels. This symbol substitutes for any other symbol within a payline apart from bonus or special “Scatter” symbols (described in more detail below). By way of example, on a payline, a player may receive the following symbols:
S4 S4 WC S4 S5 (where WC is wildcard).

Ordinarily, this would be a non-win as S4 needs to appear on 3 reels in a row, however the Wild Card substitutes as S4 so player would be paid out for having a payline of 4 of S4 symbol. A Wild Card can substitute for different symbols within the same spin. If two different winning paylines coincide with a Wild Card, it may represent a winning symbol for each respective payline.

The paytables are then adjusted and offset depending on the new features and the payouts on the skill bonus round, and, as explained above, Wild Cards may replace any symbol apart from bonus or scatter symbols. Scatter symbols are the following: Wild Card, Multiplier and Free Spin. The Wild Card has been explained above, the others are explained below.

The multiplier may be a random scatter which appears anywhere and gives the player a fixed multiple of their total stake for that spin. All scatters are random in that they will not appear at set times. The scatters are like all other symbols, though they will yield different prize results if the criteria for a Scatter win is met.

Free Spin scatter allows the player to earn free spins based on the amount of these scatters that appear on the reels. In an existing implimentation between 2-4 Free Spin scatters can appear at a time. The number of scatters provided correlate to the number of Free Spins the player receives. Free Spins are awarded at the line stake that the player was using when the player earned the Free Spins.

The screens of sklot may also include audio such as music and sound effects. For example, in the sklot introductory video, a music track may be played for a short time such as, for example, 20-30 seconds, during the sklot playout. If a player clicks to skip the video and when the video ends, the music may fade out to achieve a smooth transition. A smooth visual transition may also occur, with a gradual fading, for example.

The slot background may also music as well. A secondary theme may be played during the slot round. This theme may be looped seamlessly to create the illusion of ongoing music during extended play sessions. Win animations sounds may play on top of this music. When a player reaches the bonus round, a win animation may be played. This music may also fade out in a short time.

Bonus feature music played during the skill-game may be similar or identical to the introductory video. The bonus feature music may also be different from the introductory video music. This music may be as long as the length of the game. In an exemplary implementation, the length of the game is 1 minute. If the player finishes the game quickly the music may fade out. The music may fade out also at the end of the game as well.

Sound effects effects may be implemented for buttons on the screen, which may have a sound associated with them when they are clicked. Each win line may also have an associated sound. The associated sound may synchronize with the related visual or animation.

The sounds may be imported as MP3 files or other types of files. A clean looping point in the MP3 should be ensured, since some MP3 programs add a short space at the beginning of MP3 creation.

FIG. 12A illustrates an exemplary screen shot showing bonus multiplier animation. When the bonus feature is triggered, all win lines 640 may be animated simultaneously showing a number of currency symbols in the box corresponding to the number of win lines, instead of a win amount. In addition the multiplier animation is activated if the amount of lines selected in the bonus feature triggers is more than one.

Exemplary dimensions of sklot are 600 px×950 px (pixels). These dimensions may also be applied to the intro video. However, any dimensions that are applicable for the screen size may be implemented.

A quick loading of the introductory video may be desirable. Also, a quick start of slot game is preferable. To increase speed, the slot may load in the background during video. The slot may also load after the video. Other desirable implementation characteristics are a smooth movement into the bonus feature and a smooth movement back into slot game. The gameplay of bonus feature may be played while the slot flash is frozen, or may be played in parallel with the slot flash.

### Exemplary Registration for Playing Sklot

A sklot game may be accessed through a game site, platform or network. To play a sklot, a player may first register on the game site/platform/network and create a unique account, which will help take advantage of various loyalty schemes and claim card features in connection with the games. The player accounts can be created online or in licensed venues such as casinos, bars or retail outlets where claim cards and terminals are available. Claims cards may be linked to sites or may be linked to individual game types. In an exemplary embodiment, claim cards are linked to a site where a sklot is available. Once an account has been created, players can link their claim card to the online account. This means that the players can play from home and at licensed venues with full use of loyalty programmes, such as, for example, Lottery loyalty programmes.

Players can register their accounts in at least two ways, and registration may be a single step or a multi step registration. For example, in exemplary embodiments, a full registration can be performed, to provide full data capture, or a quick registration which allows the player to start playing immediately, but provides the partner with less information. More information can be gathered with up-sell opportunities. Players are encouraged to complete registration over time in return for benefits (e.g. tournament or prize draw entries). Registration may also include minimal data entry to start playing, with further details being captured for further incentives. For example, the player's address may be requested for registration only when the player may receive prizes, and a username may be requested for registration if the player wishes to appear on leaderboards, etc.

Players can register on the site by selecting the main graphic or a dedicated registration button. Players who register online may see a side bar on the left hand side with an option to register on it, in an exemplary visual interface.

After selecting the relevant option to register on a skill site, for full registration, the player will be presented with a registration form. It is to be noted that the skill site may be the same site or a separate site from the site or physical location that offers the core slot game. In an exemplary embodiment, a sklot could be played in an offline Casino, however the game can also be linked back (through links, and or an online account and or via the Claim Card) to an online Skill site.

Registration fields are flexible and may be defined based on partner game site specifications. The registration form may ask for standard biographical data, which is fully customisable to the specific needs of a game partner that offers the sklot on its site. Certain fields may be mandatory, so they must be filled out to complete the registration form. Once the form has been filled out, players would read the Terms & Conditions of use and confirm them by clicking the checkbox and then selecting the “Register” button. Once all the details have been correctly input, players are instructed to check for a confirmation email in their registered email address and follow the steps inside to complete the registration process. The email contains a link that should be clicked or copied in to the address bar. Visiting the link will complete the registration process.

Once a player clicks the confirmation link, they reach a page which confirms that the account is fully registered. They can now start playing games. Players are encouraged to transfer funds into a cash account, and/or play for money, and/or play for free. If players are from a jurisdiction that does not allow cash gaming, they will not see cash related options and will not be able to play for cash on the site. It is noted that any viable registration process other than the above may be used to register a player.

Partial registration may be performed instead of full registration. Partial/quick registration includes reduced data entry to start playing. Players can get started immediately using the shorter registration by clicking on a game to play directly from the homepage.

After the quick registration, players can play the game using the unique ID they created. Users may receive an activation email which they must click on to be able to use the account again. Players are required to enter full registration details in order to enter a prize tournament. Alternately players can be prompted after a set period (e.g. 3 days) to fill out their full details. If they fail to comply, they cannot make use of the benefits of the claim card or loyalty program. Data mining and player patterns can thus be observed immediately after players' registration, and additional player details may be captured for further incentives. For example, the player's address may be requested for registration only when the player is to receive prizes, and a username may be requested for registration if the player wishes to appear on leader boards, etc.

### Exemplary Sklot Features and Implementation on Gaming Platforms

Skill slots, i.e., sklots, may be available on a game platform. As previously explained, sklots are revenue driving social games. A sklot implements an innovative and novel slot application which allows players to play a skill game bonus feature within the slot environment or the environment of other game of chance. Players' success on the skill game influences the size of the bonus prize they win. Success and proficiency on the skill game increases players' winnings and the likelihood of repeat play on the sklot. Players are encouraged to practice and play the skill games online or in casino or licensed premises, within a slot game or as stand-alone skill game.

Thus, a skill game may be played within a sklot game, or played as a stand-alone game just for practice. Players can, for example, play a skill game to practice for the bonus round of a sklot. The bonus round can be a skill game as it is found on a practice site, or it may be a modified version of that same skill game, which may be configured to suit the sklot more. Skill games that may be played in the bonus round or as a stand-alone game for practicing for bonus rounds may be, for example, conventional skill games, or portions of conventional skill games, or a level of a conventional skill game which can be adapted/configured to function within a sklot game as described in the present application. Skill games that may be played in the bonus round or as a stand-alone game for practicing for bonus rounds may also be new skill games specifically designed and configured for the sklot environment, as explained in the present application. Also, the mechanics may be changed in a skill game of a sklot, to favor the player more so they have more chances if they get a zero score for one of their baseball hits, for example. Instead of being registered as 0, the player can keep trying until a positive score is attained (as long as the time limit doesn't run out).

Additional features, such as collectables and odds bonus rounds may be included in a sklot game. Collectables are in-slot collectable achievements that affect payout, bonus feature. For example, players may pick up points, or visual items may reward players for repeat play. A fixed odds bonus round may also be provided during the sklot game. In a fixed odds bonus round, the player winnings are determined at the start, however the slot and bonus round are based on a skill game, so players play the game but their payout is not determined by their skill but by an RNG.

Sklots for custom built games may also available. Custom built games may be created from scratch or as re-skins of existing games. Sklots for branded, premium or licensed games may be available as well.

Sklots may be implemented on any network or platform, for example, instant win casinos, games portal or 3rd party gaming sites. For example, sklot may be accessed through websites which have color schemes, style guides and specific languages for specific partner sites and/or countries. Sklot may be played by anyone, and may fit particularly well within the classes of casino, skill and bingo-type games. International Skill Network is one example of a game platform, with Skilljuice being an example game site within this platform.

In exemplary implementations, Sklot may be implemented using the St Endellion proprietary ridjit skill games platform, which offers a white label games platform allowing various brands/companies to offer skill games for cash or for free (depending on regulatory jurisdictions) as a stand-alone site or as part of a network of sites pooling the same player liquidity, in integrated offline or online linked products. Advertising revenues and in-play micros transactions within the ridjit applications on social media environments such as, for example, Facebook may be used in connection with costs of player acquisition. The ridjit platform offers lotteries and free or cash gaming with engaging social network features which may be used in connection with sklot games as well. Lotteries can link in store or in venue promotions with games on the online platform. 2^{nd} chance draws and offline skratch linked games and tournaments online can provide additional playing options in connection with lotteries or other gaming systems which may also be accessible through sklot games.

Sklot games may also be available through sites that offer social media platforms/social networking features like player profiles and messaging, and which specialize in Player vs. Player challenge features, allowing players to play against other online players in single matches (Matchplay) or as part of a variety of tournament types. Sklot may be linked both to in-venue real-play (such as casino, lotteries) and/or in appropriate jurisdictions linked to high margin online gaming products, which may include Sklot implementations based on the platforms of the real-play venues, or Sklot implementations based on purely online platforms. Sklot may be available on free to play sites (for example, for US lotteries) or through subscription based services, skratch linked games (pay in venue, play online) and cash skill games, depending on regulatory restrictions.

Libraries of games may be included, or provide links for the Sklot content layers, so that the Sklot game can be played inside a game from the library, on that game's site (if permissions exist), or on an independent skill site on the network by connection to the games library. Various skill games from a sklot library may be associated to be played with various slot games from another slot game library. Also, skill layers from different sklot games may be used interchangeably. Providing partner/third party consent (if required), different libraries could be inter-linked to allow players the maximum opportunity to play. Whether or not the sites have to have the partner's/third party's branding is up to the partner/third party site to decide.

The game platform may be connected to such a skill site or a non-skill site offering various games, and new networks may connect the game platform to various partner gaming sites, and 3rd party games may be integrated onto the platform. An exemplary skill site is the International Skill Network, which is a free and cash network currently provided in a number of languages, may be linked to the game platform. The network uses Euros, and players of countries which do not use the Euro may see the local equivalent per transaction. Partners joining the network receive the games currently on the network. Network partners regularly receive new games although they can decline to show any games they don't wish to offer. The availability of Sklots on a partner site depends on the partner's decision to have the features on their site. For example, Sklots and their associated features (such as tournaments, promotional banners, emails etc.) may be present on a partner site, or only the skill games that the partner wish to have on their site may be available there.

Social networking is one of the most powerful communication and leisure tool in the world today. Elements of the game platform may be integrated with social networking sites. Social interaction elements added to the game platform help acquire new players at a low cost and help increase loyalty of existing players. For example, popular social networking sites such as Facebook, Myspace, etc., may be associated with the game platform. Tools within preexisting social media environments may be built to provide input to sklot, or provide integration of sklot for users of these media environments. Such tools may include player databases, repeat-play player databases, and player trends may provide input to sklot to help set some of its parameters such as feature payout multipliers or playtables. For example, large pools of players from social media applications or environments within sites such as Facebook and Myspace may be used to build player databases in connection with the originating platform (i.e., Facebook or Myspace) through which sklot may be available, or from which a link may direct the players to an outside site where sklot is available Information regarding players' scores from player databases in social media applications may provide input to sklot games available on those sites, to help set some of the sklot parameters such as feature payout multipliers or playtables.

The number of players and other characteristics of players may be monitored on the game platform. For example, the exemplary game platform has a customer reporting system that is both user-friendly and flexible, and player statistics reports may be collated and delivered on set dates for specified periods. Traffic may be measured using visitor statistics by date and time, unique visitors, repeat visitors etc. to create player paths and optimization of acquisition campaigns. Player reports that may be generated include new player statistics, average players playing per hour of day, day of the week, or day in the month. The amount of concurrent players at any set time (or average over a set period of time) may also be extracted, to optimize player events. The total amount of each game played, minimum and maximum scores in the time period, to gauge interest levels and the base on further marketing campaigns. Results and score breakdown for tournaments to analyze tournament success may also be generated.

Players can engage with soft online gaming products which may be linked to offline products. Partner sites may join an existing network of sites on which sklot is available, to draw upon pooled player liquidity, launch a new network, or offer a stand-alone gaming experience to their customers. Sklot may be available to be played online 24/7.

The game site or platform may integrate old and new game content from various game companies. The platform may also integrate 3rd party games. Game companies may also launch their own games or request that their games be added to the game library of the site or platform. A platform or network may be configured to belong to a 3rd party game provider, or may be exclusively implemented and then bring games from 3rd parties onto the platform/network. Additional games may be added to the site to match active player growth and interest, while ensuring continued player liquidity on all games. A variety of game types may be linked onto the platform/network.

The game platform may offer multiple playing modes. Playing modes may include: matchplay, which is a 24/7 game-play against any other player choosing the same game; free play, which may be implemented on a cashless site with virtual currencies; cash play (if jurisdictional requirements allow) to play for cash, including free practice mode; and loyalty play in which points are accumulated per play and can be increased per score. Other playing modes may also be included, as the above list is not an exhaustive list of playing modes.

An exemplary games platform has a number of virtual currencies and point systems that can be used as part of an integrated loyalty program or as a standalone program. Points accumulated can redeemed for unique games, entry into prize tournaments, prize draws, branded merchandise and the like.

A CRM (Customer Relationship Management) email cycle may also be implemented on the game platform. Registered players may receive automated messages depending on their player habits encouraging them to come and play, enter tournaments, fill in surveys, enter draws and keep interacting with the site. Other messages and communications may help players through the registration or to familiarize themselves with the site, help players during their player cycle, encouraged to interact, or encouraged to come back. In addition, promotions may be used for building a relationship with players, for promoting new games/draws, for reminding people to play or for informing them of big winnings.

The game platform may be managed to provide consumer web support which may include email replies within a set period of time, dedicated contact points for escalation issues, assisted reporting and marketing support, technical reporting, 24/7 customer services, payments infrastructure together with fraud and security features, newsletters, materials targeting certain demographics, Geo-IP management to address restriction and control issues, managed hosting for application and hardware and training on new interfaces.

Technical maintenance may also be provided, to include one or more of the following: new games, new game types, reporting modules, player profile features, customer retention tools, social network features, leader-board functionality, and version upgrades that may be implemented periodically.

Flexible add-ons may be added to the game platform. For example, smart phone gaming for iPhone and android phones, or any other phone operating system may be available on the platform. Flash game operating systems may be used to implement such add-ons. The game platform may have multi lingual and currency capabilities including automated site emails and messaging, ongoing promotions and campaigns, etc.

### A. Tournaments

The game platform may also offer the option of playing tournaments. An exemplary games platform, for example, offers multiplayer online tournaments fuelling immediate interaction. Bragging rights and social networking features allow players to play for pride and achievement awards. Tournaments may be planned to encourage large scale play, and may be arranged around key performance times.

Events in the tournament may include events involving as few as 2 players, but may go up to include a large number of players. For example, an exemplary games platform may enable 5,000 concurrent players to play in a single tournament. The tournament team manages, analyzes and updates tournaments, using up to the minute info on the success and popularity of events. A scoring system based on game play may be specified for the sklot game(s) played in a tournament.

Various types of tournaments may be played on the game site. An elimination tournament is fast paced and hard hitting, and eliminates a set percent (X %) of players after each round of play. Prizes are distributed to the players lasting longest, up to the final winner which is the last man standing.

A knock out tournament is a head to head tournament, in a classic sports format. Players are pitched against a random player, and the winner progresses to the next round. Prizes are distributed to players depending on the rounds passed.

A Leaderboard tournament is a tournament which is open for a set amount of time. Players participating in the tournament play to post their best score on the leaderboard. The tournament encourages repeat-play to ensure players enter a prize winning position. At the end of the tournament, the winners will be the players who placed prize winning positions. There is no direct play against another player.

A set of tournaments with satellites includes multiple linked events. Using the success of multi table Poker tournaments, an exemplary game platform awards player's entry from a smaller tournament into a higher level tournament allowing the creation of large prize pools and multiple entry routes. Players fill the pot with repeat qualification buy-ins, as funds are rolled from one tournament to the next.

In a flexible tournament set up, each tournament is defined individually. Options include a qualifying period to enter the tournament, allowing the tournament and prize pool to grow, or Click and Go and immediate start tournaments.

Tournament payout tables can be adapted depending on the stake, game and demographic. Free play tournaments may be paid out to a certain percent of the players (for example, to 50% of players in an exemplary implementation), allowing a large amount of players to be part of the winning process. Higher staked tournaments can payout less players, to add value to the high rolling players challenging for bigger prizes per player.

### B. Leaderboards

Key features that may be available on a game platform include: player profile, contacts and messaging, and leaderboards.

The player profile is a customizable player page for bragging rights, game statistics and player communication. Players can, for example, add their own photo or use profile icons created specifically for the site. Players can interact in the game platform using an internal site messaging system or leave messages on their wall. Players can also add each other as contacts to compare scores, challenge each other and interact online, as they play sklot. Customized leaderboards may be included on the game platform. Personalized leaderboards allow players to battle for bragging rights. The leaderboards of an exemplary game platform are interactive, allowing players to compare their scores, for example their sklot scores, on each game and compare themselves with their contact list, their city, or state, etc. Players can also filter results according to the last day, week, month or all time, allowing them to find their best ranked performances. Bonus round scores may be placed on these leaderboards, or Leaderboard Points that are based on the core slot gameplay may be awarded to players. The Leaderboard Points may be awarded based on winnings, or based on time/amount played and spent in the sklot game.

The game platform may also include a site-wide point system known as the Ultimate Leaderboard. This leaderboard collates all games played and awards points per game and score on each individual game type. For example, the leaderboard collates sklot scores and non-sklot scores on sites that are inclusive with sklots. Sites which do not include sklots but are on a network which does include sklots would see no mention of sklot scores, however Leaderboard Points based on overall gameplay may be included, without specifying as to where the points were earned.

The points received on this leaderboard can also be used as the basis for loyalty promotions. Players can compare the leaderboard with their contact list, city or state over different time periods.

### C. Prize Draws and Skratchcards

The game platform may also provide the option for prize draws. Players can navigate entry point for 2^{nd} chance draws, and may be able to choose from a variety of promotions to enter valid ticket codes to play a sklot game. Valid tickets are cross checked with the tickets issued, upon data entry. A certified Random Number Generator of the game platform creates random draws and can manage player notifications and promotions. Draws can relate to offline promotions, TV promos etc. A wide number of draws can be created. Draws can be linked to games, game play and tournaments.

The game platform may also include Integrated skratchcards that may be used for a sklot game. Offline skratchcards and print promos may be linked to online games and geared towards individual customers. For example, customers may receive a Free Skratchcard or buy one to enter an online tournament, may receive multiple passwords on different tickets in different print runs, or multiple daily free tournaments. Top cash players may win entry to a monthly final. Weekly fun point satellites may be available to win entry into a monthly final, and the finals can be played online, viewed by entire site visitors, or played on TV streamed to the website or in licensed venues.

### Interactive Sklot Features

Sklot games may include slots where players can upload their own images onto the reels. Slots may be themed. For example, slots may be themed as dog, cat, faces, flowers. All pictures uploaded will likely be vetted before appearing on the public site. In addition, the gaming site may display pictures and ask players to vote on the best, and the most popular picture can then be integrated into a sklot.

Newsfeeds may also surround the picture slots so that players can keep an eye on what their friends are up to and winning. This will provide to the slot a significant social characteristic.

Players may act as affiliates. For example, players may invite friends to share their slot by adding pictures of their friends to the slot and playing on the slot may award cash/tokens, e.g. $X for every $1 wagered or Y % of every bonus round reward added to account. An example of such a game is PictureCity, which may be implemented as a sklot game. In PictureCity or similar type Sklots players may have the option to upload their pictures onto a server (such as a skill server, a skillgaming server, a slot server, a database server, a server belonging to a partner website or to a game platform, etc.), where the pictures may be stored in a storage device such as a hard drive. A player accessing a PictureCity slot may, for example, click on the image they wish to replace whereupon they will be prompted to upload a replacement image. Upon uploading the image, the server will respond and will replace that image with the newly uploaded one for that player.

Another option is to have a “Slot Editor” within the sklot, slot or skill website in which players could follow the same process as opposed to just clicking on the slot symbols in game.

A PictureCity sklot game/machine includes skill bonus round(s) characteristic to sklot games as described in the present application. PictureCity can have further social impact, whereupon players can enter their PictureCity sklot or best images into competitions on the ridjit platform or on partner sites. Other players may vote which Sklot or images are the best looking ones. The winner may then have their sklot used on the site by everyone for a set time period, or one or more winners may have their images used on a sklot.

### A. Hybrid Sklots: Youtube/Video Sklots, QuizCity, AdventureCity, Worksheet Casino Games Spreadsheet Game, ArkadeCity, Etc.

Slots may be associated with videos, by associating slots with video bonus rounds. For example, popular viral videos may be used at the end of bonus rounds, with players being required to “guess the ending” to receive additional rewards. Guessing the ending represents the skill portion of the game in this example. Correctly guessing the ending will add multipliers to the player's winnings, while incorrect guessing will leave the players with their original winnings.

### QuizCity

QuizCity slots are slots with quiz based bonus rounds. Players randomly select a winning amount during bonus round and then have the opportunity to add multipliers to their winnings. Multiple questions are presented to the players, and each question adds a further multiplier, so that the bonus round score is determined by player's skill in answering quiz questions.

### AdventureCity

AdventureCity slots are slots with choose-your-own-adventure bonus rounds. During the bonus round players are given multiple options. Each option leads to further options which will lead to different winnings at the end. Each slot may be themed but will also have a few stories so players will get different outcomes. For example, a player could be playing a platform based computer game, and path they choose will determine the bonus they receive, like the choose-your-own-adventure books that were popular in the 1980's and 1990's.

### Worksheet Casino

A Worksheet Casino Games spreadsheet game is a standard casino game that has been modified to act as a social/viral game. These games are similar to standard casino games or to sklots which will be displayed as worksheets (such as MS Excel) or documents. These games are displayed as if on a standard computer document but the mechanics and gameplay are the existing casino game mechanics. With these games, players can play a game (e.g. Roulette) on a computer. In a sklot version, the bonus feature round game could be a single click game (e.g. word or number) which would also appear within the document style format.

### ArkadeCity

ArkadeCity and similar type games provide a novel gaming environment in which each partner can have multiple environments that match their location, e.g. a US state could have X different versions, each reminiscent of a popular city in their Juristictions. ArkadeCity is a virtual skratchcard (RNG) which can offer prizes that are linked to Sklot gameplay. Each instance may include well known popular city landmarks. The game can be offered as a free game to encourage players to sign up and interact or as a bonus feature for players who interact (e.g., enter a 2^{nd} chance draw ticket and receive a free play on ArkadeCity to win prizes). Players in the environment search and click, trying to find items which they gather and receive payouts according to a skratchcard style paytable. The mechanic behind ArkadeCity is that a player keeps on “skratching” the landmarks on the virtual city until a prize is won. The prize could be, for example, free spins on the core slot game which could lead to the skill bonus feature, or a prizes could be direct play on the skill bonus feature based on a certain staked defined by the prize on ArkadeCity. Thus, the skill portion would be that players play the bonus feature and will be rewarded with a better play for good gameplay.

Players win bonuses or free spins on sklots from ArkadeCity. When playing ArkadeCity, players may also win cash, prizes, branded prizes, lottery tickets, 2nd chance draw entries, free spins on sklots, in-game sponsorship tied to real world. An ArkadeCity Daily Skratcher may also be offered to the player. The Skratcher is free. Players using ArkadeCity always receive a prize which can be used on other products or games. All prizes offer players to practice on skill environment.

While the above has been described in context of ArkadeCity, any similarly described gaming environment may be implemented.

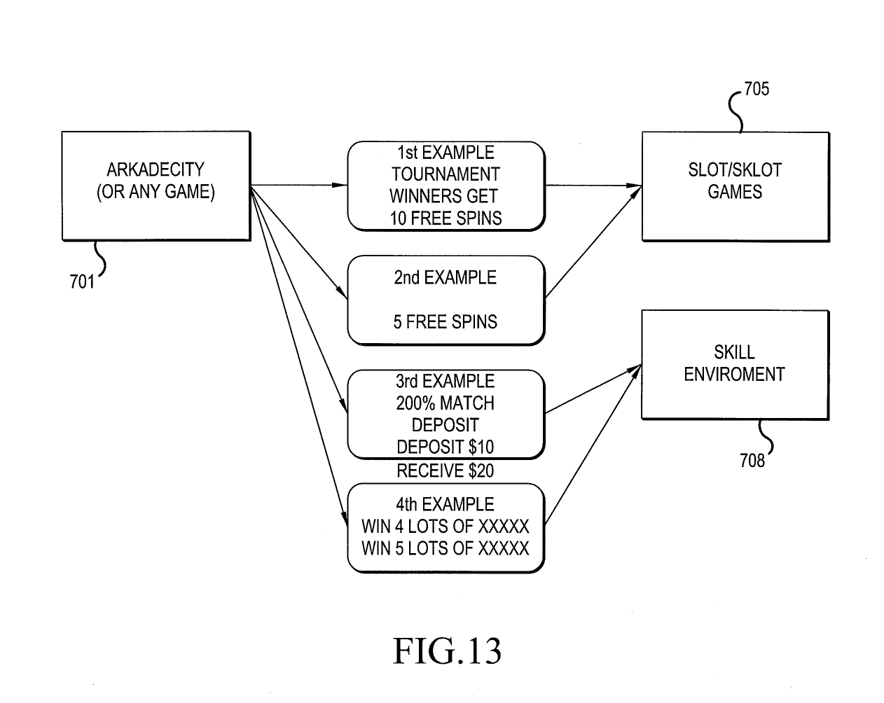

FIG. 13 is a diagram illustrating how ArkadeCity may be implemented to attract players, according to an embodiment of the present invention. Players may win bonuses or free spins on sklots from ArkadeCity. For example, players may get free spins after playing ArkadeCity in a tournament, and the free spins may be used on slot or sklot games 705. For other ArkadeCity plays, players may receive bonuses for playing on a skill site 708. In one embodiment, all activities on ArkadeCity may link players to the skill site 708 for practice. In addition, ArkadeCity incentives may be offered to players who are active on a designated skill site 708.

### Government Skill Sites

### A. Government Skill Site for Fun

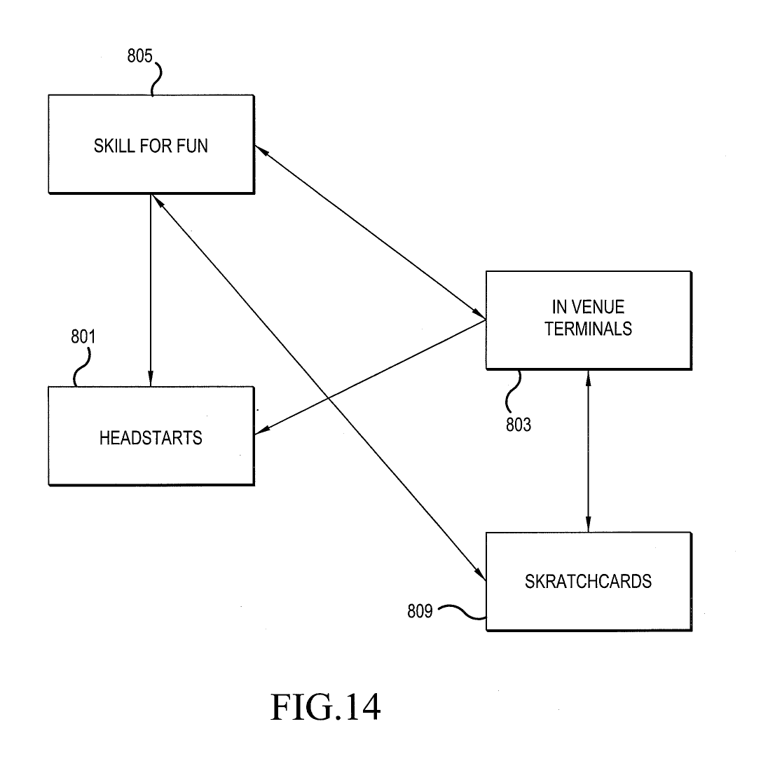

FIG. 14 is a block diagram of a system including a government skill site for fun and through which sklot may be played, and the relationship of the skill site with other gaming features and sites, according to an embodiment of the present invention. Exemplary government skill sites for fun for which skill sites may be available are the California Lottery (http://www.calottery.com/default.htm) and also the Oregon Lottery (http://www.oregonlottery.org/). Skill sites may be created for any government skill site for fun.

In FIG. 14, sections 805 and 801 may refer to the skill site, and sections 803 and/or 809 may be part of the Lottery site, or Government Approved Lottery venues and products. As shown in FIG. 14, a skill for fun site may send user information to a headstarts unit/site 801 which would recognise the user and provide a benefit/incentive to user/player. As an example, a player with 5 hits on a Jurassic Golf game may get benefits in the form of one extra hit, to get 6 hits. Of course the benefit or incentive may be anything related to game play. The “in venue” terminals 803 may also receive information from the skill for fun unit, and may require a user ID and/or password and/or card for access. The “in venue” terminals 803 include various games, some of which may be games that exist on the skill for fun site 805 as well. The “in venue” terminals 803 may also include the sklot game for free or for cash. Skratchcards unit 809 also receives information from the skills for fun unit 805 and from the “in venue” terminals 803, and provide free games and/or entry into tournaments.

In FIG. 14, the Sklot could be part of unit 805 and/or 803. Headstarts may be on separate sections, for instance, they may be a feature of the skill site and could be on the same server depending on the required setup, however they could also be on a different server when used on In Venue Terminals 803. This means that the Headstarts can function on a skill site (game platform) and also within mechanical games, which functions especially well with sklots as the Headstarts will refer to the skill bonus feature within the Sklot.

In regards to Skratchcards 809, these could be purchased in a offline retail environment, however once entered into a second chance draw, a prize or incentive for entering could be that the player earns free spins or a chance to play the bonus round of a sklot. In relation to a skill site, the Skratchcard 2^{nd} chance option could sit on the same server or it may not, depending on the setup required. In relation to In Venue terminals 803, Skratchcards may be sitting on a separate server in a preferred embodiment. They may also sit on the same server. Skratchcard prizes could be used to provide bonuses on a skill site containing sklots and also external sklot machines (in venue).

Skratchcards that are played online will work with a similar function to a standard Sklot. The RNG element of Skratchcards is the scratching to reveal symbols with the potential chance to win prizes. As part of the paytable, a bonus round is triggered when a player scratches and reveals, for example, 3 bonus symbols. This will take the player to a bonus round which will be a skill game that they can play. Online Skratchcards will have paytables which function in a similar way to sklots, with probabilities of symbols appearing defining the payouts within the RNG section of the game, with the skill bonus round paytables determining the payout based on a player's score in the skill game bonus round.

Players can play various skill games for fun online to earn loyalty points and encourage younger players, not playing traditional lotteries to interact with the lottery brands. Players can also play games and challenge for bragging rights and view leader boards, tournament results, the hall of frame and special offers. Players may also go to the In Venue Terminals 803 and play the same games for cash or as a sklot machine. The user will be recognized based on the User ID, password and card that they insert into the machine. There is also a link back to the fun site 805, so that players can practice before they play for cash.

Players who play for fun and for cash in-venue can earn head-starts from the headstarts unit 801 and game play benefits with loyalty enhancements. Cash players can earn and spend points to earn better rewards to reward their spending.

Players can purchase skratchcards from outlets (online or at physical locations) and vendors (i.e., skratchcards unit 809). Tickets can also be entered into 2^{nd} chance draws, where they can earn free games in venue or entry into tournaments.

### B. Government Skill Site for Cash

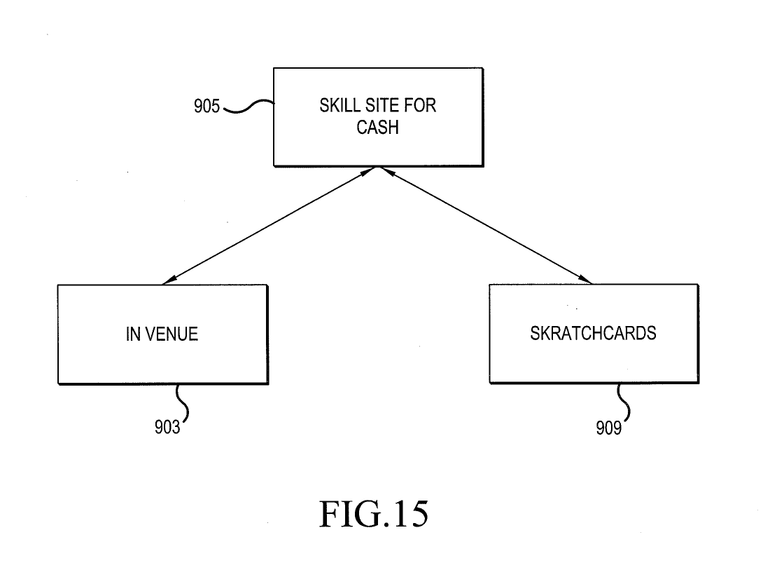

FIG. 15 is a block diagram of a system including a government skill site for cash and its relationship with other gaming features and sites. As shown in FIG. 15, a skill site for cash 905 may send information to an in-venue unit 903 and/or a skratchcards unit 909, which may send used information back to the skill site for cash unit 905.

To use a skill site for cash, a user first enters data at a terminal data entry. The ‘Create User ID’ field requires a Unique ID that the user can use repeatedly. The ‘Create Password’ field allows players to have a secret code to verify their identity, and to ensure that other people cannot access their accounts. The activate button ‘LINK CARD’ connects the information created to the new card entered in the terminals' card slot.

When a player enters a card into a terminal in a licensed premise, he may start playing depending on the registration status of the card. Registered cards allow players to start playing using any previously achieved benefits and bonuses. However, if the card has not been registered, the player is taken to the account creation screen. Player will then create a unique ID and password. When the player presses, for example, ‘Link Card’ (or other similar function) button, the card is linked to the account.

Three (3) options are available to the player after the account has been created: 1) a follow-up screen after registering asking players either for more details, or the ability to play straight away; 2) players enter the rest of the details online at home; or 3) casino/venue assistants can manually enter details and then enter the data into a computer terminal at a later stage-for example, a casino/venue assistant handing out the card to the user could request personal details which are then entered into a terminal at a later date.

After the player has entered his account details at the gaming venue, the player may start playing. When the user is at home or any other remote location, he or she can log on to the web page and fill in the rest of the details. Depending on state regulations, players can redeem skratchcards online straight into their account. Players do not have to return to a venue and can be encourage to play 2nd chance draws online. To log in, players can either use their User ID and password, or their card and password.

### Sklot in Non-Online Gaming

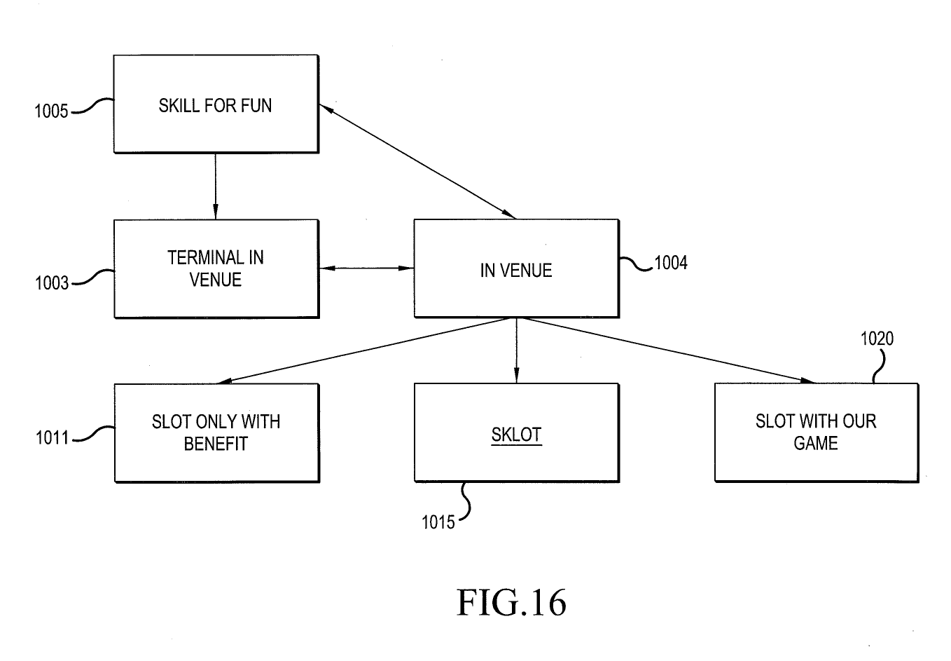

FIG. 16 is a block diagram of a system illustrating the integration of the sklot gaming feature in a non-online gaming environment. As shown in FIG. 16, a skill for fun unit 1005 introduces players to loyalty program at home and also brings online players to the non-online venue 1004. Players from an online environment can play skill games for fun on designated sites for non-online gaming operators (such as offline casinos). Players may be informed via emails and messaging that they can spend their loyalty points and earn bonuses based on their game-play in venue at the offline casinos. Players may also be informed that their favorite games online can be found at the offline casinos as sklot machines as an incentive to win cash for the games they are best at.

The non-online venue 1004 recognises the user via password, ID or card which has been registered either in venue or online. After in venue operations recognize players using their claim card or unique user ID and also their password, players may log in and play to earn the loyalty points (through either the casino's loyalty system or another loyalty system if the casino does not have one in place). Players will also be informed that they can earn further loyalty points online on designated websites of 3^{rd} party gaming partners. Players in venue will also be informed that the points that they earn offline/online and their game-play will be rewarded in venue via terminals 1003 or through the casino's own loyalty reward system.

Casinos have the option to use a sklot platform to aid in the transitioning players online into the offline venue. Sklot games and sklots inserts (i.e., a sklot play not necessarily bundled with a preexisting game) may also be used as advertising to online players. Multiple gaming options are available. For example, in venue slot machines 1011 that are linked to the venue's own loyalty system may be used by a player. The casino can also provide sklot machines 1015 to encourage online players to play offline. The casino can use also use 3^{rd} party games in slot machines 1020 with an RNG bonus round instead of skill. The user can therefore play, at a terminal in venue, or later on an online site which communicates with a terminal in venue or a venue server, a sklot game, a slot and/or a slot only game with benefit.

The terminal in venue may award in-hand cash/tokens from game-play either online on the skill for fun site, or in venue. Players can also access Loyalty Terminals in venue. Terminals will recognize either card number or unique ID, and password. Players can also insert their card and then password to access the loyalty balance. Benefits can be picked up from the terminal, any prizes from game-play can be redeemed and loyalty points can be spent on the rewards that the casino will offer. If required, points can be split into casino and site points, depending on the casino's balancing policy between player on site play time and earned rewards in venue. The loyalty program may also be implemented in such a way that the best or preferential rewards are only earned from casino game play, or that a massive amount of points may be earned online.

### Integration of Sklot in Multiple Environments

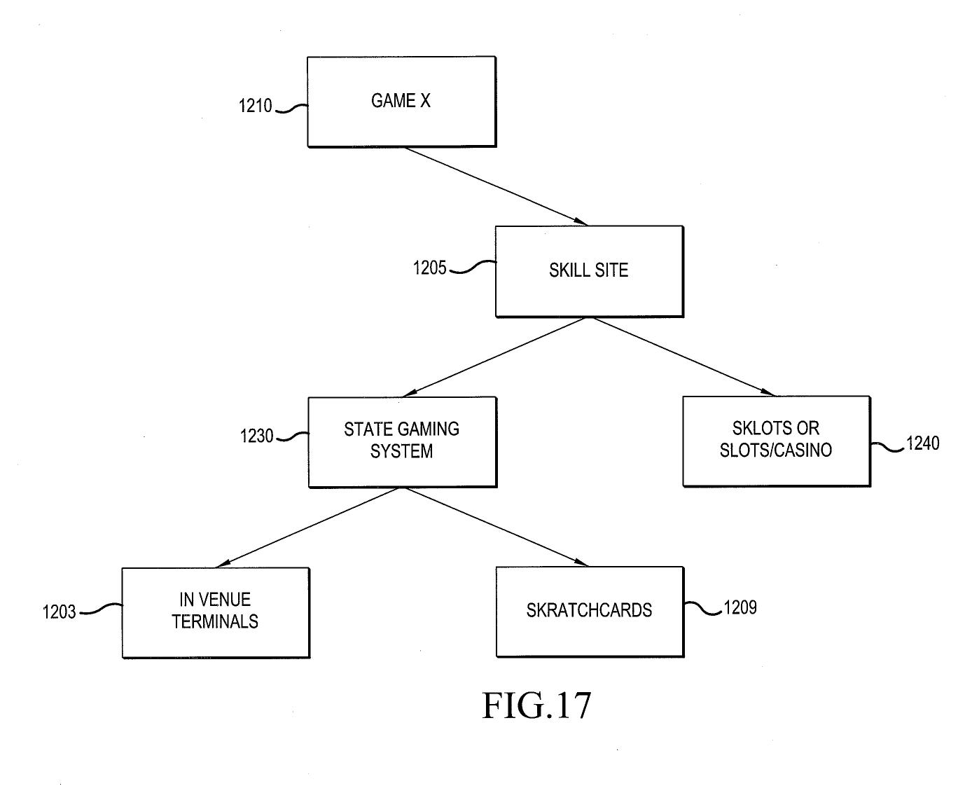

FIG. 17 is a block diagram illustrating the integration of the sklot gaming feature in social networking environments and gaming environments. Players can play a skill game X on a social networking site 1210 such as Facebook or Myspace. Having games on social networking sites increases player awareness of the games, which become more accessible and recognisable. Players can register on the skill site 1205 using their social networking site account details (for example, using their Facebook account details). Depending on the way the games are set up on the social networking site, players may also connect to the game's company main product site using their social networking log-in.

A percentage of the overall population of players who play on games from social networking sites can be classified as dedicated players who may be interested in the skill site. Players who join the skill site will be able to play a wider range of games and will also have the opportunity to play on sklots to win money or tokens by playing their favourite games. The skill site may also redirect players to a State gaming system 1230, such as, for example, a State Lottery website or other government owned outlet, casino or website.

Players can click on the Government Site link to access the lottery products and play games on the lottery brand. If possible, players can log in with their social networking details which could be linked to a claim card, otherwise they can create a new user ID with password and register for a claim card. Players can then use the government account to access the loyalty program and play on IVTs and purchase skratchcards (from skratchcard unit 1209), which can be claimed online and used for 2nd chance draws.

If a player clicks on the sklots link from the skill game site 1205, they will be taken to a 3^{rd} part sklot/casino website 1240. Depending on the 3^{rd} party's preference, the player can log in through their social networking user or they may need to create an account with the operator of the site.

### Player Reactivation Features

Reactivation mechanisms may be used to encourage a player to resume activity. A typical email reactivation email sent to players by an online gaming company usually follows the format of “Come back for X (10-100 units of currency)”.

An exemplary reactivation email in connection with sklot play may be “Come back to play in our 10,000 freeroll tournament, you are guaranteed to win X”. The players targeted may be player's who are lapsed and whose most played game is the game in the freeroll. All players who return to play freeroll following this message will receive a payout.

A reactivation email may also offer a bonus for playing on a certain 3rd party site. The bonus may have conditions that must be fulfilled before the funds are released to the player's account.

Another type of reactivation email may dispense with such conditions. Once a player's favourite game has been determined and when a large freeroll is available for that game, lapsed players may be sent a reactivation email inviting them to participate in the tournament. All qualifying positions in the tournament will win money which is a guarantee. This type of reactivation message may be more successful than one that places conditions on release of reactivation funds/tokens.

The amount of prize money guaranteed per player return may be determined based on the number of players that show up for the freeroll. For example, while the reactivation email may have stated a certain amount of prize money/tokens for player return (i.e., the guaranteed amount), the actual amount may be increased if less than the entire number of lapsed players (i.e., less than the number of emails sent to lapsed players) will show up to play the freeroll.

The freerolls may be limited to a pre-selected maximum amount of players that are able to qualify. If the freerolls are not to be limited to a number of players, an advertisement may be sent to all qualifying players that they will win cash/tokens, but not specify/guarantee how much cash or token per player.

### Player Conversion

The statistics of converting a skill game player to a player of a hard gaming site show that, on average, 3% of the players convert to cash immediately, 6% of the players still play for fun. Continued fun play and sklot incentives encourage free players to play for cash, i.e., help convert a player playing style from fun to cash. For example, winners of for fun tournaments can be awarded a percentage of free spins on sklots. This helps introduce for fun players as potential cash players.

Players who play for fun can also be converted to harder gaming products by getting prizes relating to games of greater difficulty when they win tournaments. For example, a 100 free spin X game tournament could distribute prizes amongst top players, with the winner earning, for example, 25 free spins on Sklot X and the other players receiving lesser amounts based on position until all 100 free spins have been allocated. Players who enjoy the game are more likely to be encouraged to play the games slot, with success on the game reaping rewards from successful sklots bonus features. After the player plays on Sklot X, the player will need to follow casino operator guidelines to withdraw funds (e.g., depositing and wagering to verify account).

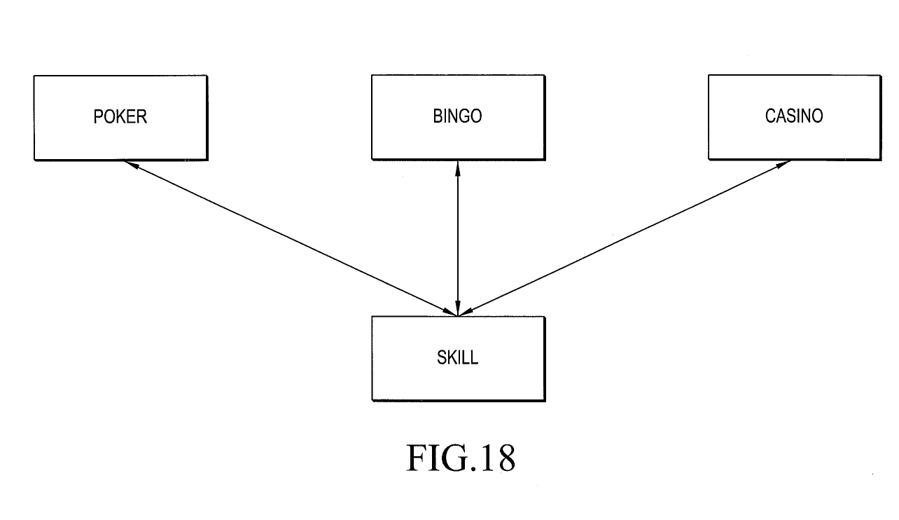

Free players from other platforms may also be encouraged to play for fun on skill. If such players play on Sklot X, they will believe, correctly, they have a better chance of winning. FIG. 18 illustrates aspects of the operation of converting players from other platforms to play for fun on the skill sklot. Other platforms such as Poker and Bingo, etc, may be implemented to be combined with a skill gaming portion such as described above with respect to sklot.

The present disclosure describes a sklot game which is a skill game where players win money or other rewards based on their ability as opposed to a random pre-determined payout. The process of slot-skill-slot plays when a bonus round occurs. The bonus round includes a bonus paytable which relates scores directly to the multiplier of the slot stake. Multiple lines triggering a bonus feature may provide multipliers to the stake of the bonus round, and multiple feature symbols on a payline may increase the payout based on the bonus paytables. An API flash container solution allows game configuration and customisation, so that a section of the full game can be provided as the bonus round without taking a very long time.

Although detailed embodiments and implementations of the present invention have been described above, it should be apparent that various modifications are possible without departing from the spirit and scope of the present invention. For example, while the methods, units and software applications have been described above in the context of slot games the principles of the current invention apply equally to other games of chance besides slot games, so that a skill game is triggered in the game of chance whereby players win money or other rewards based on their ability as opposed to a random pre-determined payout. Modifications and adaptations of the present invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or may be acquired from the practicing of the invention. For example, the described implementation includes software, but systems and methods consistent with the present invention may be implemented as a combination of hardware and software or hardware alone.

Additionally, although aspects of the present invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

We claim:

1. A gaming system comprising:
a unit for a game of chance;
a skill unit; and
a skillgaming unit,
wherein the units are programmed to operate so that:
the unit for the game of chance sends a request for a bonus round game session to the skill unit, during a game of chance played by a player, when a predetermined scenario occurs in said game of chance,
the skill unit sends session information to the unit for the game of chance,
the unit for the game of chance sends bonus round characteristics to the skillgaming unit, for the bonus round to be played by the player as a skill game,
the skillgaming unit sends a player score from said bonus round so that the score reaches the unit for the game of chance.

2. The gaming system as recited in claim 1, wherein the game of chance is a slot game.

3. The gaming system as recited in claim 1, further comprising a server controlling tournaments to enable the use of scores from the bonus feature in a tournament.

4. The gaming system as recited in claim 1, further comprising a display unit illustrating at least one of a paytable function, a stake function, a lines function, a maxbet function, a spin function and an autospin function.

5. The gaming system as recited in claim 1, wherein said paytable function launches a paytables section showing what the player can win on the game of chance and on the bonus feature.

6. The gaming system as recited in claim 1, wherein said skillgaming unit or said unit for the game of chance are accessed from a social networking site.

7. The gaming system as recited in claim 1, wherein said unit for the game of chance, skill unit and skillgaming unit are located at the same physical location.

8. The gaming system as recited in claim 1, wherein
said unit for the game of chance and said skill unit are located at different physical locations,
said unit for the game of chance is an online unit or an in-venue gaming unit, and
said skillgaming unit is provided at one of: an online location, a casino, and a government-sanctioned gaming facility.

9. The gaming system as recited in claim 1, wherein said skillgaming unit is accessed by the player on-site or remotely using a user account.

10. The gaming system as recited in claim 1, wherein said unit for the game of chance provides a reward to the player based on the score sent by the skillgaming unit.

11. The gaming system as recited in claim 1, wherein
said skill unit is located at an online site separately from said unit for the game of chance, and
a bonus round is played by the player on the skillgaming unit, at the location where said unit for the game of chance is located.

12. The gaming system as recited in claim 1, wherein
said skillgaming unit enables a player to practice a skill game which is similar to the bonus round, without accessing the unit for the game of chance.

13. The gaming system as recited in claim 1, wherein
said unit for the game of chance includes slots which display a plurality of pictures.

14. The gaming system as recited in claim 1, wherein
said unit for the game of chance includes at least one slot surrounded by a newsfeed describing the activity of another player.

15. The gaming system as recited in claim 1, wherein
the score is determined by the player's skill.

16. The gaming system as recited in claim 1, wherein
the score is determined by the player's skill, said score affecting a likelihood for a win in said game of chance.
